(19) United States
(12) Patent Application Publication
(10) Pub. No.: US 2012/0304053 A1
(43) Pub. Date: Nov. 29, 2012

(54) DISPLAY APPARATUS, DISPLAY METHOD, AND PROGRAM

(75) Inventor: Tadashi Yamaguchi, Saitama (JP)

(73) Assignee: Sony Corporation, Tokyo (JP)

(21) Appl. No.: 13/576,722

(22) PCT Filed: Dec. 20, 2011
(86) PCT No.: PCT/JP2011/007095

§ 371 Date: Aug. 2, 2012

(30) Foreign Application Priority Data
Dec. 27, 2010 (JP) 2010-289767

(51) Int. Cl. G06F 17/00

(52) U.S. Cl. 715/251

(57) ABSTRACT

Techniques are disclosed for displaying content on an electronic book having a plurality of physically distinct displays configured to be turned by a user. A content page may be calculated for display on a display page with number Dm, different from the currently opened display page number Dn. The content page may be calculated based at least in part on a ratio between Dd and Dr, where Dd is a difference between Dm and Dn, and Dr is a number of display pages between the currently opened display page and a beginning or end of the available display pages formed by the plurality of displays of the electronic book.

### TECHNICAL FIELD

Some embodiments described in the present application relate to a display apparatus where a plurality of display portions are configured to be openable in a form of, for example, an electronic book or the like, a display method of the display apparatus, and a program.

### CITATION LIST

### Patent Literature

[PTL 1] Japanese Unexamined Patent Application Publication No. 2007-333797
[PTL 2] Japanese Unexamined Patent Application Publication No. 2007-333973
[PTL 3] Japanese Unexamined Patent Application Publication No. 2002-287690

### BACKGROUND ART

An electronic book configured with a plurality of displays has been known. For example, in a technique disclosed in Patent Document 1, when the number of electronic papers is smaller than the number of content items, first, the content items corresponding to the number of electronic papers are displayed, a button disposed on the last page or the like is pushed, and the display of the entire electronic papers is updated with the next page of the content page after that which has been displayed just before.

In addition, in a technique disclosed in Patent Document 2, rotation type electronic paper sheets are used, so that, every time when the page is turned, the content is switched to the next content data item.

Patent Document 3 discloses a technique for display a large size of data on electronic papers.

### SUMMARY OF INVENTION

### Technical Problem

However, in the openable book type electronic book where paper-shaped displays are attached in a book shape, intuitive usage of a user cannot be embodied unlike a general paper book.

For example, in the case where “the vicinity of the last portion of this book is desired to be viewed” or “the vicinity of ⅓ of the novel is desired to be read again”, it is difficult to cope with the opening of the vicinity of the requested page by the intuitive page turning.

Therefore, some embodiments described in the present application allow a so-called electronic book type display apparatus to properly cope with the intuitive page turning of a user.

### Solution to Problem

Some embodiments relate to apparatus for displaying content on an electronic book having a plurality of physically distinct displays configured to be turned by a user, the plurality of displays forming a number Da of available display pages, the electronic book being configured to allow the user to view at least a portion of a content unit divisible into a number Ca of available content pages, the apparatus comprising at least one processor; and at least one memory storing processor-executable instructions that, when executed by the at least one processor, perform a method comprising determining a number Dn of a currently opened display page from among the available display pages; determining a number Dm of a first display page different from the currently opened display page from among the available display pages, and a difference Dd between Dm and Dn; determining a number Dr of display pages between the currently opened display page and a beginning or end of the available display pages; calculating a first content page from among the available content pages to display on the first display page, based at least in part on a ratio between Dd and Dr; and causing the first content page to be displayed on the first display page.

Some embodiments relate to a method for displaying content on an electronic book having a plurality of physically distinct displays configured to be turned by a user, the plurality of displays forming a number Da of available display pages, the electronic book being configured to allow the user to view at least a portion of a content unit divisible into a number Ca of available content pages, the method comprising determining a number Dn of a currently opened display page from among the available display pages; determining a number Dm of a first display page different from the currently opened display page from among the available display pages, and a difference Dd between Dm and Dn; determining a number Dr of display pages between the currently opened display page and a beginning or end of the available display pages; calculating, using at least one processor, a first content page from among the available content pages to display on the first display page, based at least in part on a ratio between Dd and Dr; and causing the first content page to be displayed on the first display page.

Some embodiments relate to at least one computer-readable storage medium encoded with a plurality of computer-executable instructions that, when executed, perform a method for displaying content on an electronic book having a plurality of physically distinct displays configured to be turned by a user, the plurality of displays forming a number Da of available display pages, the electronic book being configured to allow the user to view at least a portion of a content unit divisible into a number Ca of available content pages, the method comprising determining a number Dn of a currently opened display page from among the available display pages; determining a number Dm of a first display page different from the currently opened display page from among the available display pages, and a difference Dd between Dm and Dn; determining a number Dr of display pages between the currently opened display page and a beginning or end of the available display pages; calculating a first content page from among the available content pages to display on the first display page, based at least in part on a ratio between Dd and Dr; and causing the first content page to be displayed on the first display page.

According to some embodiments, in an electronic book type display apparatus where one-side ends of a plurality of display portions are integrally attached and which is configured to be openable, it is possible to implement display corresponding to intuitive page turning of a user, so that the electronic book can be used with a usage feeling like a general paper book. Accordingly, it is possible to greatly improve the usability of the electronic book type display apparatus.

### BRIEF DESCRIPTION OF DRAWINGS

FIG. 1 is a diagram illustrating a structure of an electronic book according to an embodiment.

FIG. 2 is a diagram illustrating display of the electronic book according to the embodiment.

FIG. 3 is a diagram illustrating display of the electronic book according to the embodiment.

FIG. 4 is a diagram illustrating difficulty of intuitive page turning in the electronic book.

FIG. 5 is a block diagram illustrating a configuration of the electronic book according to the embodiment.

FIG. 6 is a diagram illustrating an example of a functional configuration of a controller of the electronic book according to the embodiment.

FIG. 7 is a diagram illustrating a display state management table according to the embodiment.

FIG. 8 is a diagram illustrating an example of a page opening detection method according to the embodiment.

FIG. 9 is a flowchart illustrating a process of the electronic book according to the embodiment.

FIG. 10 is a flowchart illustrating a content display process according to the embodiment.

FIG. 11 is a diagram illustrating a display state in a process procedure according to the embodiment.

FIG. 12 is a flowchart illustrating a display updating process according to the embodiment.

FIG. 13 is a flowchart illustrating a content page calculation process in a first mode according to the embodiment.

FIG. 14 is a flowchart illustrating a content page calculation process in a second mode to a fourth mode according to the embodiment.

FIG. 15 is a flowchart illustrating an updating mode selection process example I according to the embodiment.

FIG. 16 is a flowchart illustrating an updating mode selection process example II according to the embodiment.

FIG. 17 is a flowchart illustrating an updating mode selection process example III according to the embodiment.

FIG. 18 is a diagram illustrating an example of another functional configuration of the controller according to the embodiment.

FIG. 19 is a flowchart illustrating a process of the electronic book which performs predictive updating according to the embodiment.

FIG. 20 is a flowchart illustrating a predictive display updating process according to the embodiment.

FIG. 21 is a flowchart illustrating a content page calculation process of performing adjustment of page determination according to the embodiment.

### DESCRIPTION OF EMBODIMENTS

Hereinafter, embodiments will be described in the following order. In addition, a display apparatus according to an embodiment is an electronic book.

1. Overview of Electronic Book

2. Internal Configuration of Electronic Book

3. Display Control Process

3-1: Overall Processes

3-2: Content Displaying Process

3-3: Display Updating Process

3-3-1 First Mode

3-3-2 Second Mode

3-3-3 Third Mode

3-3-4 Fourth Mode

3-3-5 Other Examples

3-4: Updating Mode Selecting Process

3-4-1 Process Example I

3-4-2 Process Example II

3-4-3 Process Example III

3-5: Summary of Updating Mode Selection and Display Updating Process

4. Display Control Process for Performing Predictive Updating

5. Display Updating Process for Performing Content Page Adjustment

6. Modified Example

7. Program

### 1. Overview of Electronic Book

In an electronic book as a display apparatus according to an embodiment, one-side ends of a plurality of display portions are integrally attached in a book shape and is configured to be openable.

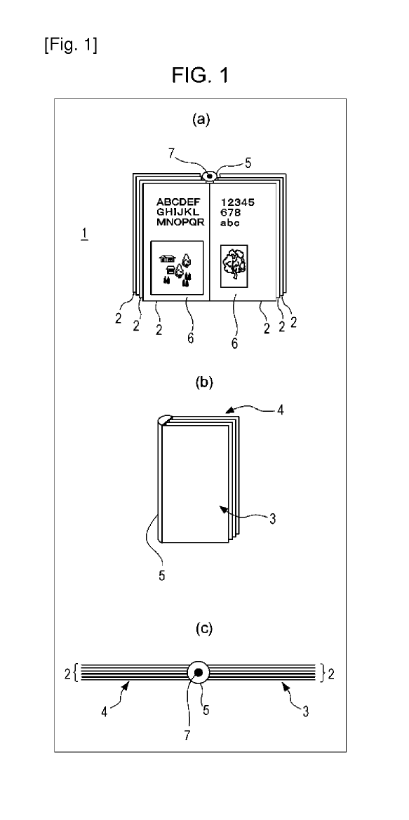

FIG. 1 illustrates an overview of the electronic book 1.

In addition, for the convenience of description, terms “display page” and “content page” are used.

The “display page” is a page which is numbered in the display portion 6 attached in a book shape from “1”. The terms “display portion 6” and “display page” exemplarily correspond to a “display portion” and a “display portion page” in the aspect of the present disclosure. In order to distinguish from the content page, the number of pages of the display page is attached with “Disp” before the number so as to be denoted as “Disp1”, “Disp2”, and the like.

The “content page” is a value of a page assigned to the content data. One content page denotes a unit displayed one display portion 6.

FIG. 1 (a) schematically illustrates a state where some of display portions 6 and 6 of the electronic book 1 are opened; FIG. 1 (b) schematically illustrates a state where the electronic book 1 is closed; and FIG. 1 (c) schematically illustrates a state where the electronic book 1 in the opened state is viewed from the upper side.

The electronic book 1 is configured in a book shape so that the ends of a plurality of physically distinct display sheets 2 (hereinafter, referred to as “sheets 2”) are bound at the book spine 5 side.

Two front and rear surfaces of the sheet 2 or one surface thereof become the display portions 6. In the example of this figure, the two surfaces of the sheet 2 are set to the display portions 6, and as illustrated in FIG. 1 (a), the display portions 6 appear at the left and right in the facing state.

For example, in this configuration, the plurality of display portions 6 are configured so that the ends thereof are integrally attached at the book spine 5 side and the display portions 6 are openable.

In addition, the display portion 6 may be configured with a display device such as a liquid crystal panel, an organic EL (Electroluminescence) panel and this may be fixed and attached on all or a portion of the front and rear portions of the sheet 2. Alternatively, as an organic EL sheet, an electronic paper, or the like, the display portion 6 itself may be configured in a thin sheet shape; or the display portion 6 itself may constitute the sheet 2.

In addition, the form of attachment of the sheet 2 to the book spine 5 is not particularly limited. Like papers of a typical book, the end of each sheet 2 may be fixed, or individual sheets 2 in a binder form may be detached or added.

In addition, the sheet 2 may be configured so as to be rotatable about the book spine 5 side as a rotation axis.

As illustrated in FIG. 1 (b) and FIG. 1 (c), a front cover portion 3 and a back cover portion 4 are disposed. The front cover portion 3 and the back cover portion 4 may be formed as display portions 6 or may not be formed as the display portions 6.

For example, the front side of the first sheet 2 is set to the front cover portion 3, and the rear side thereof is set to the display portion 6 which is set to the display page Disp1. In addition, a display portion 6 for the front cover or as the display page Disp1 may also be disposed at the front cover portion 3 side.

In addition, the rear side of the final sheet 2 is set to the back cover portion 4, and the front side thereof is set to the display portion 6 which is set to the last display page. In addition, a display portion 6 for the rear cover or as the last display page may also be disposed at the front cover portion 3 side.

If the display portion 6 is disposed at the front cover portion 3 or the back cover portion 4, the display portion 6 may be used for displaying a title of the content data or the like.

Actually, although a variety of the configurations or the display methods of the display portions 6 may be considered, in the description hereinafter, irrespective of whether or not the display portion 6 exists on the front cover portion 3, the front side of the first sheet 2 (that is, the rear surface of the front cover portion 3) through the rear side of the last sheet 2 (that is, the rear surface of the back cover portion 4) are set to the display portions 6, which display the detail of the content data, as the display pages Disp1 to DispX.

As illustrated in FIG. 1 (c), for example, a page updating button 7 is installed on the upper surface side of the book spine 5. The page updating button 7 is a manipulator which is manipulated by a user when the user desires to display the content pages equal to or larger than the number of display pages.

In addition, the page updating button 7 may be installed at the other positions, for example, on the lower surface of the book spine 5, on the front cover portion 3, or on the back cover portion 4.

In such an electronic book 1, content data are acquired, and the content data are displayed on each of the display portions 6. For example, content units such as novels, essays, articles, scholarly books, or photo books are loaded to be displayed. Like a typical book, a user may view the details of the content while turning pages (display pages).

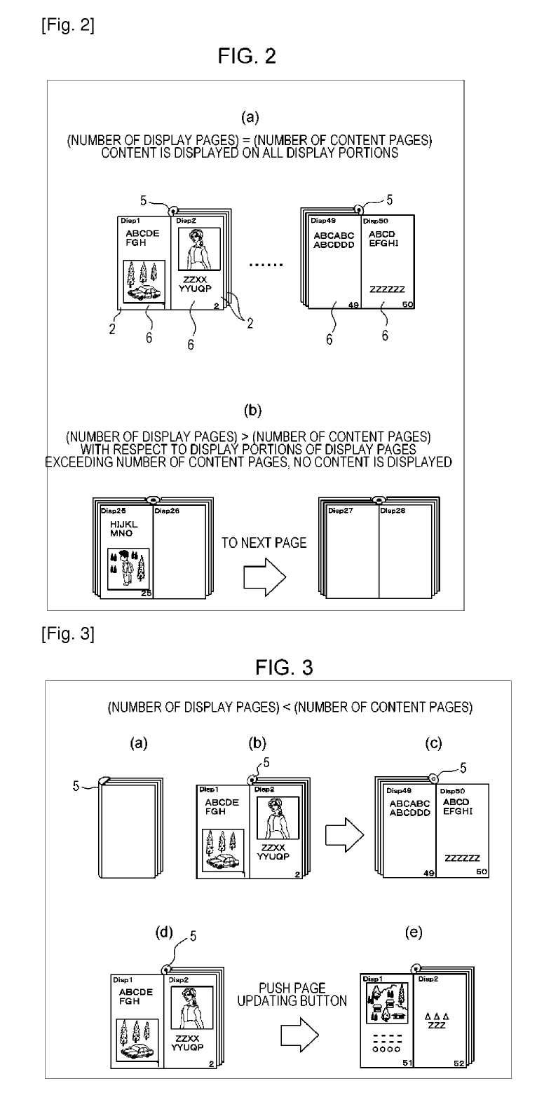

Herein, a basic display format of the detail of each page of the content data on the plurality of display portions 6 is described with reference to FIGS. 2 and 3.

(a) of FIG. 2 illustrates the case where the number of the display pages is equal to the number of the content pages.

For example, it is considered that the number of the display pages is 50; and the number of content pages is 50.

In this case, as illustrated in this figure, the display is made in such a manner that the first content page corresponds to the first display portion 6 (display page Disp1); the second content page corresponds to the second display portion 6 (display page Disp2); . . . ; the 50th content page corresponds to the 50th display portion 6 (display page Disp50).

In addition, in this figure, although an example where the value (“Disp1”, “Disp2”, or the like) of the display page is displayed at the upper left portion of each of the display portions 6 is illustrated, in fact, the display page may not be displayed. For the convenience of description, in FIGS. 2 to 4, and FIG. 11, the displaying of the display page is added.

In addition, in each figure, the value of the content page is indicated by a number of the lower right portion of each of the display portions 6. In general, when a user reads a book by using the electronic book 1, the user recognizes the content page.

(b) of FIG. 2 illustrates the case where the number of the content pages is smaller than the number of the display pages.

For example, it is assumed that the number of the display pages is 50 and the number of the content pages is 25. In this case, as illustrated in this figure, the content pages 1 to 25 are displayed on the display pages Disp1 to Disp25, and any of the content pages are not displayed on the following display pages (Disp26 to Disp50).

(a) to (e) of FIG. 3 illustrate the cases where the number of the content pages is larger than the number of the display pages.

For example, there is a case where the number of the display pages is 50 and the number of the content pages is 100.

In this case, first, as illustrated in (a), (b), and (c) of FIG. 3, the content of the pages up to the 50th page corresponding to the number of display pages are displayed. In other words, the content pages 1 to 50 are displayed on the display pages Disp1 to Disp50.

If a user pushes the page updating button 7 in this state, the display detail is updated. In other words, the content pages 51 to 100 are displayed on the display pages Disp1 to Disp50. As illustrated in (d) and (e) of FIG. 3, with reference to the display pages Disp1 and Disp2, after the page updating button 7 is pushed, the display of the initial content pages 1 and 2 is switched to the display detail of the content pages 51 and 52. Therefore, in the case where a user sequentially reads pages in the forward direction, after the user reads the last display page Disp50, the user pushes the page updating button 7, so that the subsequent content page may be read from the display page Disp1.

The electronic book 1 according to the embodiment may basically perform the aforementioned display according to the relationship between the number of the display pages and the number of pages of the to-be-displayed content data.

However, it is not always possible to cope with the intuitive page turning of the user by only the above manner. This is described.

First, as illustrated in (a) of FIG. 2, when the display page=the content page, the user may use the electronic book 1 with the same feeling as that for a general book with respect to the page turning. It is also possible to perform the intuitive page turning.

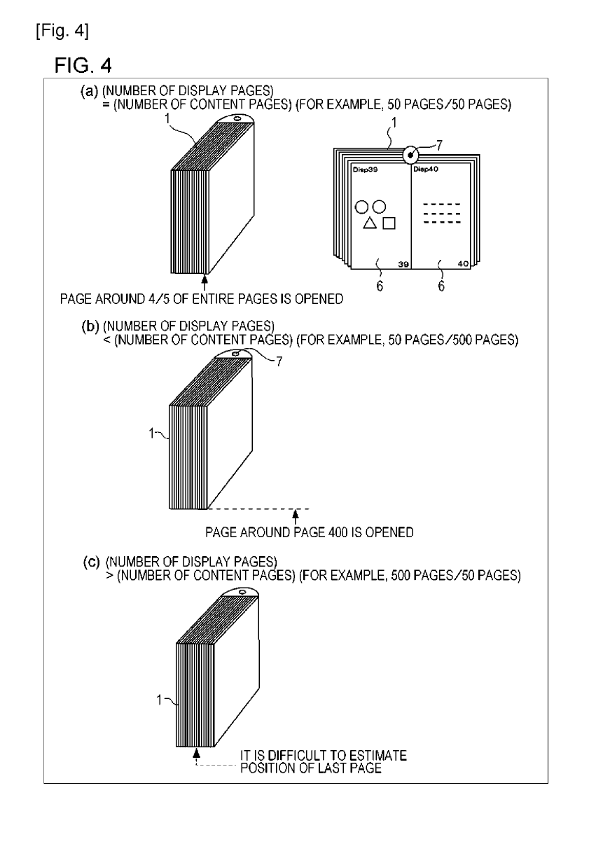

As illustrated in (a) of FIG. 4, for example, it is considered that the user desires to view the vicinity of ⅘ of the content data from the state where the electronic book 1 is closed. For example, it is considered that the user desires to view the vicinity of page 40 with respect to the content data having a total of 50 pages.

In this case, similarly to a general book, the user intuitively decides and opens the vicinity of ⅘ of the entire pages. By doing so, for example, the vicinity of the 40th page may be opened. Although this is not the page which the user desires to view, it is possible to relatively easily find the desired page by searching the preceding and following pages.

However, this is only the case where the display page=the content page, and this is because the display page is always coincident with the content page.

In fact, the case where the display page=the content page is a rare case, and in many cases where various content data are loaded on the electronic book 1 to be used, it is considered that the number of the display pages is not equal to the number of the content pages.

Therefore, problems of the following examples occur.

For example, as illustrated in (b) of FIG. 4, the case where the number of display pages is smaller than the number of content pages is considered.

First, when the user desires to turn several pages at one time, since the front page which can be turned does not exist in the portion equal to or larger than the number of display pages, there is a problem in that it is not possible to intuitively turn the pages like a real book.

For example, in the case where the number of display pages=50 and the number of content pages=500, it is considered that the user desires to view the vicinity of ⅘ of the entire pages (for example, the vicinity of 400th page) when the electronic book is in the closed state, when the user reads the vicinity of the 10th page of the content data, or the like.
In this case, in fact, since the display page as the 400th page does not exist, the page turning may not be performed.
In addition, although the user intuitively considers the vicinity of the 400th page to be “the page of the back side of the book” and opens the page of the back side (display page), the vicinity of the content pages 40 to 50 is displayed, so that the user cannot view the page.
As a result, it is necessary to search for the desired page by repeating the manipulation of the aforementioned page updating button 7 or the like.

In addition, therefore, when the number of display pages is smaller than the number of content pages, the page separated by the number of display pages or more and the current page are simultaneously opened, so that the user cannot check the two pages.

In the above example, for example, in the case where the user desires to simultaneously view and compare the 10th page and the 400th page of the content data, since the display needs to be updated by the manipulation of the page updating button 7, the user cannot check the two pages. In comparison with a general book, it is very inconvenient.

In addition, if the number of display pages is smaller than the number of content pages, since the pages of which the number is equal to or larger than the number of the display pages are not displayed, the vicinity of the last page may not be intuitively opened without notice. In this case, it is necessary to search for the vicinity of the last page through the manipulation of the page updating button 7.

On the other hand, as illustrated in (c) of FIG. 4, in the case where the number of display pages is larger than the number of content pages, there is a problem.

When the number of display pages is larger than the number of content pages, since the pages of which the number is equal to or larger than the number of the display pages are not displayed, the vicinity of the last page may not be intuitively opened without notice. First, as described with reference to (b) of FIG. 2, in this case, with respect to the display pages exceeding the number of the content pages, no content is displayed. In other words, as illustrated in (c) of FIG. 4, the vicinity of the last page of the content data cannot be intuitively predicted from the thickness of the electronic book 1 which is formed in a book shape. Although the vicinity of the last display page is intuitively opened, no content is displayed therein. This is because the last page of the content data is the “page in the vicinity of the back cover of the book”.

For this reason, as a result, it is inconvenient to search for the vicinity of the last page. In the case where the user desires to view a middle page, the inconvenience also occurs. Since the position of the last page of the content data cannot be predicted, although the user desires to view the “page in the vicinity of almost the middle of the book”, this is because the content page which the user desires to view is not the display page in the vicinity of the middle of the thickness of the electronic book 1.

Similarly to this example, in the electronic book 1, only in the aforementioned basic display method, the display corresponding to the intuitive page turning of the user cannot be performed unlike a general paper book.

Therefore, in the embodiment, when the plurality of display portions are turned at one time, the content page prior to the content page corresponding to the number of the turned displays is displayed. Alternatively, when the plurality of display portions are turned at one time in the page backward direction, the content page before the content page corresponding to the number of the turned displays is displayed.

In addition to this display control, the content display corresponding to the intuitive page turning of the user is implemented.

For this reason, as described above, the electronic book 1 having the plurality of display portions 6 includes a controller (later-described controller 21) which performs display control corresponding to the intuitive page turning.

The controller 21 determines the content page which is to be displayed on the display portion page in the opened state of the second state through calculation using the number of target display portion pages which is the number of all the display portion pages which are in the same direction as a page turning direction by using the display portion page in the current state (first state) as a reference, the number of target content pages which is the number of all the content pages which are in the same direction as a page turning direction by using the content page which is to be displayed on the display portion page in the current state (first state) as a reference, and the page difference value between the display portion page in the current state (first state) and the display portion page in the second state.

More specifically, based on the calculation of the content page of which the ratio to the number of target content pages is equal to the ratio of the page difference value to the number of target display portions, the content page which is to be displayed on the display portion 6 which is next in the opened state is determined.

Next, control of displaying the detail of the determined content page on the display portion 6 which is next in the opened state is performed.

In addition, particularly, when the number of turned pages is equal to or larger than a predetermined number (for example, equal to or larger than five pages), the controller 21 determines the content page which is to be displayed on the display portion which is next in the opened state through the calculation using the number of target display portions, the number of target content pages, and the page difference value.

### 2. Internal Configuration of Electronic Book

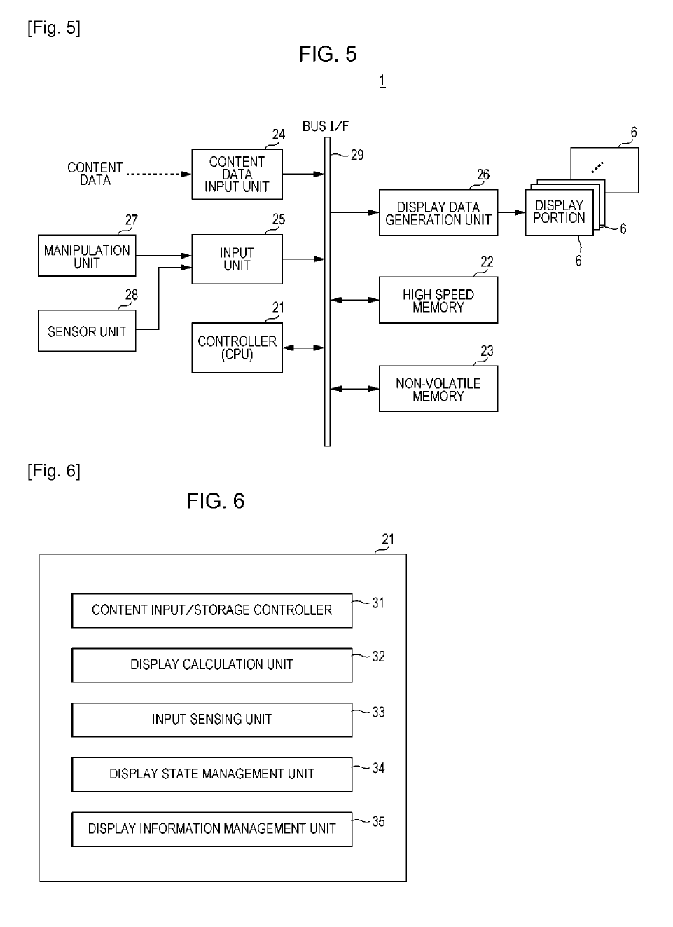

FIG. 5 illustrates an example of an internal configuration of the electronic book 1. In addition, in the configuration described hereinafter, electric circuit portions or a necessary power supply system (not shown) such as a battery may be disposed in an inner portion of the book spine 5, an inner portion of the sheet 2 where the display portion 3 or the back cover portion 4 is formed, or the like.

The electronic book 1 has a configuration for performing the displaying on the display portions 6 as illustrated in, for example, FIG. 5. The electronic book 1 includes a controller 21, a high speed memory 22, a non-volatile memory 23, a content data input unit 24, an input unit 25, a display data generation unit 26, a manipulator 27, a sensor unit 28, and a bus OF 29.

The controller 21 is constructed with, for example, at least one processor such as a CPU (Central Processing Unit) to control overall operations of the electronic book 1. The controller 21 has the function described with reference to FIG. 6 to perform the later-described display process according to the embodiment.

The high speed memory 22 is configured with a DDR-SDRAM (Double-Data-Rate Synchronous Dynamic Random Access Memory) or the like which may be accessed at a relatively high speed. A program for executing of the process of the controller 21 (CPU) is loaded thereon, or various data are temporarily stored therein.

For example, the high speed memory 22 is used to store the input content data, the later-described additional information of the content data, the display information, the display state table, and the like.

The non-volatile memory 23 is configured with a flash memory or the like to retain the program executed by the controller 21 (CPU). In addition, the non-volatile memory 23 may also be used to store the input content data or the additional information.

In addition, a storage medium constituting the high speed memory 22 or the non-volatile memory 23 is not limited to the DDR-SDRAM or the flash memory. The high speed memory 22 may be other types of RAMs such as an S-RAM, a D-RAM, or an SDR-SDRAM. In addition, an HDD (Hard Disk Drive), a memory card, or the like may be used as the non-volatile memory 23. In addition, a ROM (Read Only Memory) may also be used.

The content data input unit 24 is a component which inputs the content data in the electronic book 1. For example, the content data input unit 24 is configured with a media driver, a communication unit corresponding to wired communication or radio communication, or the like.

The content data are considered to exist in a removable memory card configured with a semiconductor memory or the like or on a server via a network. In addition, the content data are considered to be written in an external apparatus communicably connected to the electronic book 1, a magnetic recording apparatus such as an HDD built in the electronic book 1, a semiconductor memory, an optical disc, or the like.

For example, in the case where the content data (and the additional information of the content data) are supplied by a memory card or a recording medium such as an optical disc, the content data input unit 24 may be formed as a card reproducing apparatus or a disc reproducing apparatus so as to read the content data from the memory card. Alternatively, this may also be configured with an HDD.

In addition, in the case where the content data are supplied through communication from an external apparatus or network communication, the content data input unit 24 is configured as a communication unit to receive and acquire the transmitted content data and additional information.

In this manner, the content data and the additional information which are input through the reproducing and receiving of the content data input unit 24 are stored in the high speed memory 22 or the non-volatile memory 23 under the control of the controller 21.

Although the content data acquired by the content data input unit 24 are stored in the high speed memory 22 or the non-volatile memory 23, the data which are stored at one time may be the entire content data or a portion thereof.

For example, in the case where the content data are supplied to a recording medium such as a memory card, the content data input unit 24 may read a portion of the content data including the portion which is necessary for the current display operation among the content data and store the portion in the high speed memory 22 or the non-volatile memory 23 under the control of the controller 21. In other words, if necessary, a portion of the content data may be acquired.

Hereinafter, for simplification, the description is made in the configuration where the entire content data are acquired by the content data input unit 24 at one time and stored in the high speed memory 22 or the non-volatile memory 23.

In addition, the additional information of the content data includes title information, management information, size information, and the like of the content data and, in the case of this example, the page information (content page information) and the later-described index page information of the content data.

The input unit 25 receives an input from the manipulator 27 or an input of a detection signal from the sensor unit 28, performs a necessary decoding process, and transmits input information (manipulation information or detection information) to the controller 21.

The manipulator 27 corresponds to, for example, a manipulator of the afore-mentioned page updating button 7 or the like. Besides the page updating button 7, in some cases, other manipulators such as a power button, manipulators for various setting manipulations, or the like may be disposed.

The controller 21 receives manipulation input information of the user using the manipulator 27 from the input unit 25 and performs a necessary control process.

The sensor unit 28 is a sensor which is configured to detect the display page which is opened (is to be opened) by the user.

The controller 21 receives the detection signal from the sensor unit 28 through the input unit 25, recognizes which of the display pages is opened, and performs a necessary display control according to the opened display page. The details are described later.

Various configurations of the sensor unit 28 may be considered.

As a method of detecting the page opening, besides a method of directly recognizing the opened display page, there are a method of detecting contact between the display pages and recognizing the opened display page from this, and a method of detecting an angle between a consecutive display portions 6 attached to the book spine and recognizing the opened display page.

As the method of directly recognizing the opened display page, an illuminance sensor configured with a phototransistor or a photodiode is considered to be disposed between the pages. In this case, if some display page is opened, the illuminance sensor detects illuminance of the external light. In this case, the controller 21 recognizes that the facing left and right display pages where the illuminance sensor which detects the external light is disposed are opened.

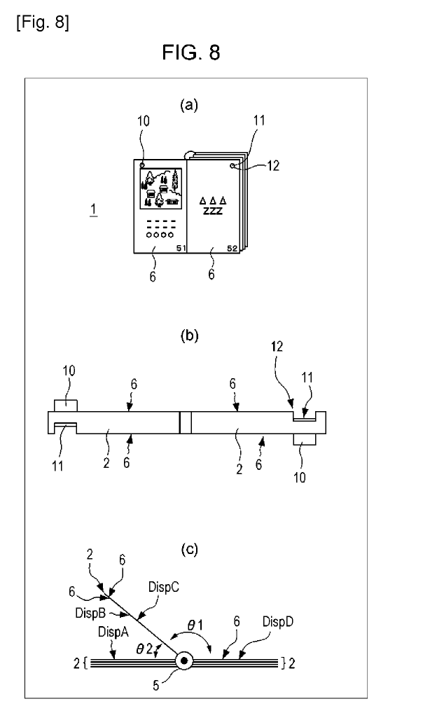

The method of detecting the contact between the display pages are configured as follows. For example, as illustrated in (a) and (b) of FIG. 8, in the odd-numbered display page, a protrusion 10 is disposed on the page; and in the even-numbered display page, a recess 12 corresponding to the protrusion 10 are disposed. A switch 11 is disposed within the recess 12. In addition, it is configured that the switch 303 is pushed by the protrusion 10 in the state where the display page is closed.

The controller 21 may recognize the opening and closing of the display pages by monitoring the state (switch on/off signal) of the switch 10. In other words, the two facing display pages where the switch is pushed may be determined to be in the closed state; and the two facing display pages where the switch is not pushed may be determined to be in the opened state.

In the example of (a) and (b) of FIG. 8, although it is configured that the protrusion 10 is disposed in the odd-numbered display page and the switch 12 is disposed in the even-numbered display page, other configurations where the switch 10 is disposed in the odd-numbered display page and the protrusion 10 is disposed in the even-numbered display page may be employed.

In addition, as the method of detecting the angle between the display portions 6 and detecting the page opening, a rotation angle sensor capable of measuring the angles (theta1 and theta2) between display pages illustrated in (c) of FIG. 3 may be considered to be buried in the book spine 5.

The detection information of the rotation angle sensor is input, so that the controller 21 can recognize that the two facing display pages which are opened at an angle equal to or larger than a certain angle are the pages in the opened state.

For example, if the opened angle theta between the display pages is equal to or larger than 30 degrees, since the angle theta2 between the display pages DispA and DispB of (c) of FIG. 8 and the angle theta1 between the display pages DispC and DispD are equal to or larger than 30 degrees, all of the facing pages are considered to be in the opened state.

In addition, if the pages of which the first angle theta is large are considered to be opened, in the case of (c) of FIG. 8, only the display pages DispC and DispD are considered to be in the opened state.

However, in the case where the rotation angle sensors are used, since the rotation angle sensors corresponding to the number of pairs of the display portions 6 need to be prepared, as the number of the display portions 6 (number of sheets 2) is increased, the configuration is complicated.

Returning to FIG. 5, the display data generation unit 26 performs a process for displaying the content data which are acquired from the content data input unit 24 and stored in the high speed memory 22 or the non-volatile memory 23 on each of the display portions 6 according to the command of the controller 21.

In other words, the display data generation unit 26 receives the content page designated by the controller 21 and configures the display screen of the to-be-displayed content page.

For example, since the content data are stored in an HTML (Hypertext Markup Language) format, an EPUB (electronic publication) format, a JPEG (Joint Photo graphic Experts Group) format, or the like, the data are decoded by the display data generation unit 26, and the screen configuration is generated. The generated screen data are transmitted to each of the display portions 6 to be displayed.

As described with reference to FIG. 1, a plurality of the display portions 6 are disposed.

Each of the display portions is managed with the display page number which is counted from 1 by the controller 21. Next, each of the display portions 6 performs a display operation according to the screen data supplied from the display data generation unit 26.

The display portion 6 may be configured with any of thin type displayable devices such as a liquid crystal display, a plasma display, an organic EL display, and an electronic paper.

A bus I/F 29 performs transmission of various data between the components while performing control through embedded adjustment functions.

In the electronic book 1 having the configuration described hereinbefore according to the embodiment, in order to implement the later-described display control process, the controller 21 has a functional configuration illustrated in FIG. 6.

FIG. 6 illustrates blocks of functions implemented by the controller 21 (CPU) executing processes based on the program. Therefore, the blocks of the function may be considered to be functional blocks formed by software in the controller 21.

In addition, herein, although each block is described as a function embodied by software, each block may be configured as a unit embodied by hardware, and the entire blocks may constitute a control circuit corresponding to the controller 21 to be installed in the electronic book 1.

As illustrated in FIG. 6, the controller 21 includes, as functional blocks, a content input/storage controller 31, a display calculation unit 32, an input sensing unit 33, a display state management unit 34, and a display information management unit 35.

The content input/storage controller 31 controls operations of acquiring content data and additional information from the aforementioned content data input unit 24 and operations of storing the content data and the additional information in the high speed memory 22 or the non-volatile memory 23.

In other words, the content input/storage controller 31 performs control of reproducing or receiving operation of the content data input unit 24 and control of transmitting and writing the acquired content data and additional information to a memory (22 or 23).

In addition, the content input/storage controller 31 performs a process of transmitting the content data to the display data generation unit 26 for a display process, a process of checking the additional information, or the like.

The additional information such as the number of pages of the content data is used for calculation of the display content page determination in the display calculation unit 32.

The display calculation unit 32 performs a process of determining the content page which is to be displayed on each of the display portions 6. More specifically, the determination of the content page which is to be firstly displayed on each of the display portions 6 when power is turned on or the like or the determination of the content page which is to be displayed on each of the display portions 6 according to manipulation of the page updating button 7 is performed.

In addition, particularly, in the case according to the embodiment, as a process according to the page turning of the user, in order to respond to the intuitive page turning, a process of determining the content page which is to be displayed on the display portion 6 is performed. In other words, the calculation as to which content page is allowed to be displayed on which display page is performed. The details of the calculation are described later.
In order to perform this process, the display calculation unit 32 refers to the additional information of the content data (number of the content pages, the page information, the index page information, or the like) from the content input/storage controller 31 or the later-described display information, or the information of the display state management table.
The display calculation unit 32 determines which content page is allowed to be displayed on which display page, transmits the information to the display data generation unit 26 to generate a display image, and performs necessary display updating.

The input sensing unit 33 performs a process of detecting information from the input unit 25, that is, information of user manipulation or opening and closing information of each display page by the sensor 28.

The display state management unit 34 manages the displayed detail of each of the current display pages (content page) by using the display state management table.

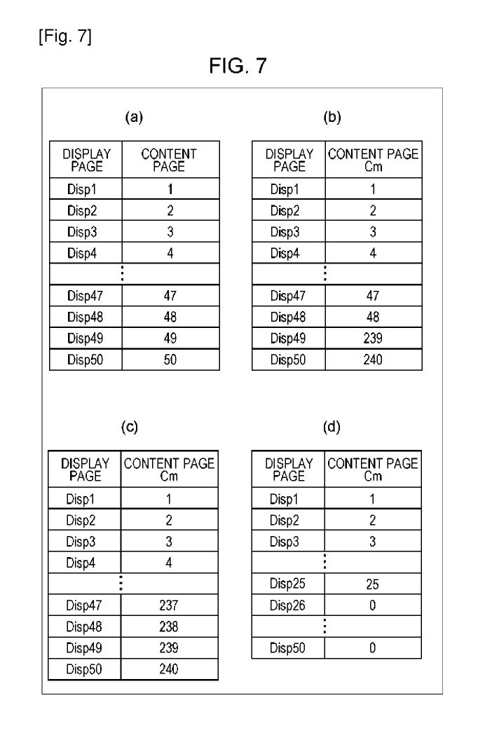

FIG. 7 illustrates an example of the display state management table.

As illustrated in (a) of FIG. 7, the display state management table is configured as a table for managing the display pages and the content pages, which are displayed on the display pages, in a correspondence manner. For example, in the case where there are 50 display pages, the content page numbers are stored in correspondence with the display pages Disp1 to Disp50.

The display state management table is stored in, for example, the high speed memory 22 or the non-volatile memory 23. Next, the display state management unit 34 rewrites the detail of the display state management table with reference to the display state management table if necessary or according to the updating of the displayed detail through the calculation of the display calculation unit 32.

For example, (a) of FIG. 7 is an example corresponding to the initial display state.

For example, it is considered that the number of the display portions 6 is 50, in other words, the number of the display pages is 50; and the displaying of 240 pages of the content data is performed.

After the electronic book 1 is powered on, first, the content pages 1 to 50 are allowed to be displayed on the display pages Disp1 to Disp50, respectively.

At this time, the display state management unit 34 sets the detail of the display state management table as illustrated in (a) of FIG. 7. In other words, the table information is set so that the display page Disp1, the display page Disp2, the display page Disp3, the display page Disp4, . . . , the display page Disp48, the display page Disp49, and the display page Disp50 correspond to the content page 1, the content page 2, the content page 3, the content page 4, . . . , the content page 48, the content page 49, the content page 50, respectively.

Herein, as the later-described process, the display calculation unit 32 is configured to allow the content pages 239 and 240 to be displayed on the display pages Disp49 and Disp50 according to the page turning of the user. In this case, the display state management unit 34 updates the details of the display state management table as illustrated in (b) of FIG. 7. In other words, the table information is updated so that the display page Disp49 corresponds to the content page 239 and the display page Disp50 corresponds to the content page 240.

In addition, it is considered that the user turns one page backwards from the state in which the content pages 239 and 240 are opened. In this case, through the later-described process, the display calculation unit 32 displays the content pages 237 and 238 on the display pages Disp47 and Disp48. In this case, the display state management unit 34 updates the detail of the display state management table as illustrated in (c) of FIG. 7. In other words, the table information is updated so that the display pages Disp47 and Disp48 correspond to the content pages 237 and 238.

In this manner, the display state management unit 34 always allows the displayed detail of each of the current display pages to be illustrated by the display state management table, so that the controller 21 always checks the content page which is displayed on each of the current display pages.

The display information management unit 35 manages information of the display portion 6 of the electronic book 1. The display information management unit 35 manages the number of the display portions 6, that is, the number of the display pages as one of the display information.

Each sheet 2 (display portion 6) of the electronic book 1 is configured so that it may be able to be removed or added. Therefore, in the case where the number of display pages is likely to be changed, the display information management unit 35 updates the information on the number of display pages according to the removal or addition of the display portion 6.

For example, since the controller 21 manages the display portions 6 by the display page numbers which are consecutive from 1, the number of the display portions 6 attached to the book spine 5 may be calculated by reading the maximum value.

In addition, in the case of the electronic book 1 having a configuration where the number of the display portions 6 is fixed, the display information management unit 35 may manage the number of display pages as a fixed value.

In addition, the display information management unit 35 manages the display page which is viewed by the user, that is, which is in the opened state, as display information.

As described above, the display page which is in the opened state is checked by the controller 21 (input sensing unit 33) detecting the detection information of the sensor unit 28.

The display information management unit 35 determines the display page number of the display page which is currently in the opened state based on the detection information from the sensor unit 28 and stores the display page number.

In addition, the display information management unit 35 also performs determining and storing of the display page number of the display page which is next in the opened state according to the page turning of the user.

Information on the display page which is currently in the opened state and information on the display page which is next in the opened state are appropriately transferred to the display calculation unit 32, so that the information is used for a calculation process for determining to-be-displayed content page.

### 3. Display Control Process

### 3-1: Overall Processes

The display control operation of the electronic book 1 having the aforementioned configuration is described.

Hereinafter, the processes described with reference to flowcharts are the processes which are executed by the controller 21 having the functions of FIG. 6 based on a program.

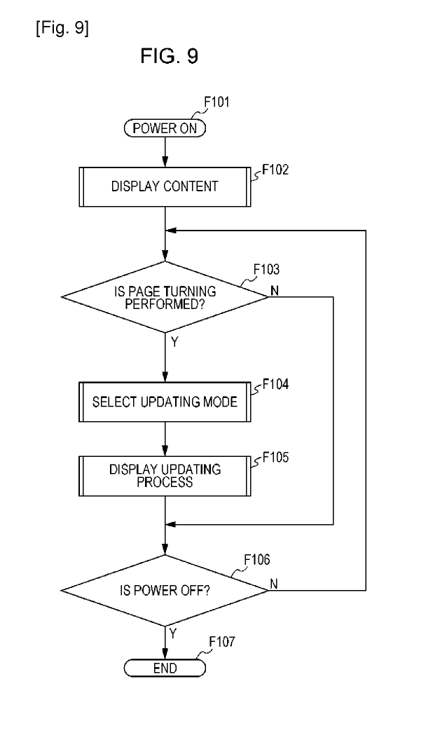

First, overall processes from power-on to power-off are described with reference to FIG. 9.

If the power of the electronic book 1 is manipulated to be turned on, the process of FIG. 9 is started, so that the controller 21 performs power on and driving processes in Step F101. In addition, for example, in the case where a power button is disposed to the manipulator 27, the power-on is performed by a power manipulator of the user. Alternatively, for example, it may be configured that the power is turned on when the electronic book 1 is opened.

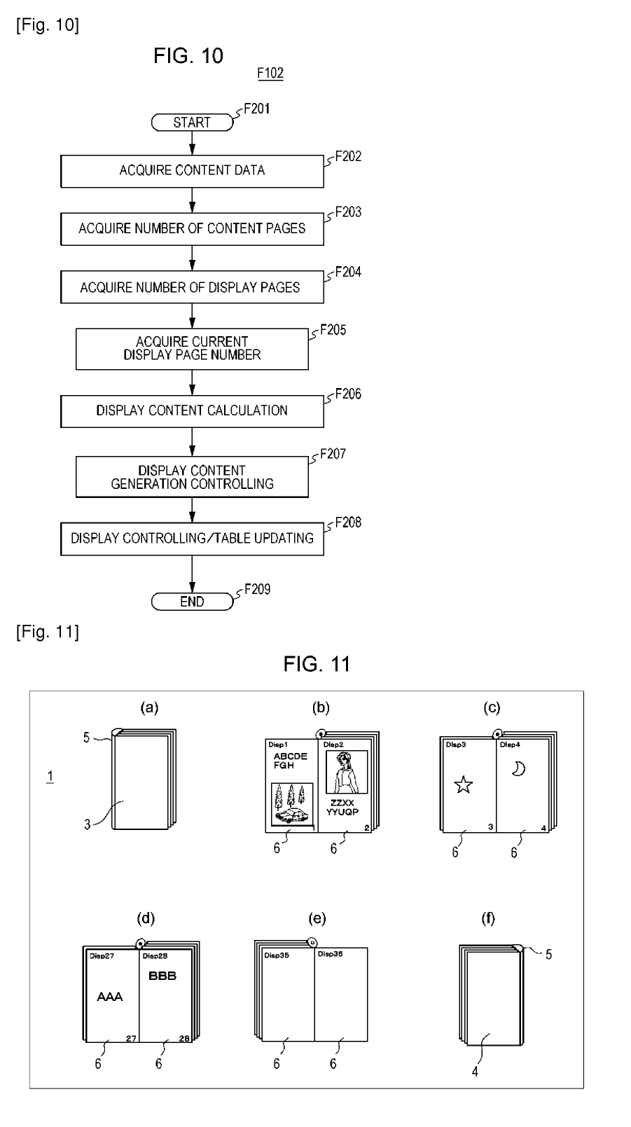

After the power is turned on, the controller 21 performs a control process for the content display in Step F102. Although Step F102 is described in detail with reference to FIG. 10, for example, as an initial display state, the display described with reference to FIG. 2 and FIG. 3 is performed on each of the display portions 6.

For example, if the number of display pages=the number of content pages, as illustrated in (a) of FIG. 2, the content page is displayed on each of the display portions 6.

In addition, if the number of display pages>the number of content pages, as illustrated in (b) of FIG. 2, the content pages are displayed on the display portions 6 corresponding to the number of content pages, and no content is displayed on the remaining display portions 6.
In addition, if the number of display pages<the number of content pages, as illustrated in (a), (b), and (c) of FIG. 3, as much as it is possible to firstly display the content pages on the entire the display portions 6, the displaying of the content pages is performed. In Step F102, the process according to the functions of the content input/storage controller 31, the display calculation unit 32, and the display state management unit 34 in the controller 21 are mainly performed.

In Step F103, the controller 21 determines whether or not a page is turned.

Determination of whether or not a page is turned is performed by acquiring the opening/closing information of the display portion 6 from the input unit 25 and allowing the controller 21 to receive the result.

Next, the controller 21 acquires the display page number which is retained up to now (display page number of the display page which is currently in the opened state) by the function of the display information management unit 35 and compares the display page number with the next display page number which is detected by the input sensing unit 33 (display page which is next in the opened state).

If the newly detected display page number is different from the display page number which is retained up to now, it is determined that the page is turned, and the process proceeds to Step F104.

If the newly detected display page number is the same as the display page number which is retained up to now, it is determined that the page is not turned, and the process proceeds to Step F106.

In this manner, the process of Step F103 is mainly the process according to the functions of the input sensing unit 33 and the display information management unit 35 in the controller 21.

In Step F104, the controller 21 selects the updating mode.

The controller 21 selects an optimal updating mode according to the number of display pages, the display page number which is detect to be newly opened, the display page number of the display page which is opened up to now, and a display page turning method. The details of the selection of the updating mode are described later. If the updating mode is selected, the process proceeds to Step F105.

The process of Step F104 is mainly the process according to the functions of the display information management unit 35 and the display calculation unit 32 in the controller 21.

The controller 21 performs the display updating in Step F105.

The controller 21 performs the calculation by the algorithm according to the updating mode selected in Step F104 and, as a result, performs the calculation of the content page which is to be displayed on the newly opened display page. Next, the controller 21 commands the display data generation unit 26 to display the content page and to perform the necessary display updating on the display portion 6. In addition, the controller 21 also performs updating the display state management table according to the updating.

An example of the calculation process for the display updating according to each updating mode is described later.

The process of Step F105 is mainly the process according to the function of the display calculation unit 32 and the display state management unit 34 in the controller 21.

If the display updating control is performed, the controller 21 proceeds to Step F106.

In Step F106, the controller 21 determines based on the information acquired through the input unit 25 whether or not the power is turned off. Herein, if the power is determined to be turned off, the process is ended in Step F107. If the power is not turned off, the controller 21 proceeds to Step F103 to continuously perform the main process.

In addition, although omitted in FIG. 9, as illustrated in FIG. 3, in the case where the number of content pages is the number of display pages and the user pushes the page updating button 7, the updating of the display detail is performed as described with reference to FIG. 3 (d) and FIG. 3 (e).

### 3-2: Content Displaying Process

Details of the content display process of Step F102 of FIG. 9 are illustrated in FIG. 10.

The controller 21 starts the content display process in Step F201. In Step F202, the controller 21 performs the content data acquisition control. In other words, the controller 21 commands the content data input unit 24 to acquire the content data and the additional information and to transmit the content data and the additional information to the high speed memory 22 or the non-volatile memory 23 to be stored therein.

In Step F203, the controller 21 acquires the number of content pages. In other words, the controller 21 extracts the information on the number of pages of the content data from the additional information of the content data.

In addition, the acquired additional information of the content data may not necessarily include the information on the number of pages of the content data, e.g., the number of available content pages in the content unit.

For example, if size information of the content unit exists, the number of available content pages may be calculated by using the size information and the data amount which is to be displayed on one display portion 6. In addition, if individual page number information exists in the content data, the number of pages may also be calculated with reference to the information.

In this manner, the controller 21 checks the number of pages of the content data and retains the value thereof. For example, if the content data correspond to 50 pages, (number of pages)=50 is retained.

Subsequently, in Step F204, the controller 21 acquires the number of the display portions 6, e.g., the number of available display pages in the electronic book.

As described above, if the display portions 6 are detachable, at this time, the number of available display pages is checked by counting the number of the display portions 6 attached to the book spine 5. In the case where the display portions 6 are configured not to be detachable, the number of available display pages may be loaded as a fixed value.

In Step F205, the controller 21 acquires the currently opened display page number. In this case, the controller 21 detects the detection information of the sensor unit 28 from the input unit 25 and checks the currently opened display page number.

According to this process, it may be monitored which display page of the electronic book 1 is opened just after the power is turned on.

For example, in the case as illustrated in (a) of FIG. 11, since the electronic book 1 is in the closed state in terms of only the front cover portion 3 when it is externally viewed, the current display page number=“0”.

In addition, in the case of (b) of FIG. 11, since the display pages Disp1 and Disp2 are in the opened state, the current display page number=“1” and “2”.

Next, in Step F206, the controller 21 performs the calculation of the display content. In other words, first, the controller 21 performs the calculation as to which content page is to be displayed on which display portion 6 from the acquired number of pages of the content data and the acquired number of display pages.

Next, as a result of the calculation in Step F207, the controller 21 generates command information indicating which content page each of the display pages is displayed on.

For example, if the number of display pages=50 and the number of content pages=50, the command information for allowing the content pages 1 to 50 to be displayed on the display pages Disp1 to Disp50 is generated.

In addition, if the number of display pages=50 and the number of content pages=25, command information indicating that the content pages 1 to 25 are displayed on the display pages Disp1 to Disp25 and no content is displayed on the display pages Disp26 to Disp50 is generated.

In addition, the number of display pages=50 and the number of content pages=100, command information indicating that the first 50 pages of the content data, that is, the content pages 1 to 50 are displayed on the display pages Disp1 to Disp50 is generated.

In this manner, the controller 21 supplies the generated command information to the display data generation unit 26 in Step F207.

In response to this, the display data generation unit 26 performs a process of generating to-be-displayed content page. In other words, the display data generation unit 26 generates the display image (page data) by the content page commanded from the controller 21 with respect to the display pages Disp1 to Disp50.

The content data stored in the high speed memory 22 or the non-volatile memory 23 includes page configuration, characters, pictures, or the like, and the decoding of the content data is performed, so that the page data corresponding to the display pages are generated.

In Step F208, the controller 21 commands the display data generation unit 26 to perform display.

The display data generation unit 26 transmits each of the generated page data to each of the display portions 6 to perform display. By doing so, the detail of the content pages based on the calculation result of the controller 21 is displayed by each of the display portions 6.

In other words, the display state according to the relationship between the content pages and the number of the display pages described with reference to FIGS. 2 and 3 may be obtained as the initial display state.

In addition, at this time, the controller 21 updates the display state management table. For example, as a case similar to (a) of FIG. 2 or FIG. 3, in the case the content pages 1 to 50 are displayed on the display pages Disp1 to Disp50, as illustrated in (a) of FIG. 7, the display state management table is updated to the state where the content pages “1” to “50” are stored in correspondence with “Disp1” to “Disp50”.

As a case similar to (b) of FIG. 2, in the case where the content pages 1 to 25 are displayed on the display pages Disp1 to Disp25 and no content is displayed on the display pages Disp26 to Disp50, the display state management table becomes that of (d) of FIG. 7. In other words, the controller 21 updates the display state management table to the state where the content pages “1” to “25” are stored in correspondence with Disp1” to “Disp25” and “0” is stored in correspondence with “Disp26” to “Disp50”. “0” denotes the value indicating the state where any one is not displayed.

If the above process is performed, the controller 21 ends the content display process of the power-on time in Step F209.

### 3-3: Display Updating Process

As described above with reference to FIG. 9, in the case where a user performs the page turning, the updating mode is selected in Step F104, and the display updating process is performed in Step F105.

Herein, an example of the display updating process performed in Step F105 after the updating mode selection is described.
In the embodiment, as an example, as the updating mode which can be selected in Step F104, there are first to fourth modes.
Next, in Step F105, the content page which is to be displayed on the turned display page is determined by the algorithm according to one of the first to fourth modes, and the display control is performed. In other words, the controller 21 calculates the content page which is to be displayed on the after-page-turning display page by using one or a plurality of the number of pages on the content, the current content page, the number of display pages, the current display page number, and the after-page-turning display page number.
It is described later which of the updating mode (first to fourth modes) is used in which case, and the first to fourth modes are as follows.

The first mode is the mode where the content page which is to be displayed on the display page after the pages corresponding the number of page turnings performed by the user is performed is determined as the one page updating operation, and the first mode is applied to the case where the page turning of a small number of pages such as one or several pages is performed.

The second mode is the mode where, in the case where the electronic book 1 is opened from the closed state, the content page suitable for being displayed on the display page which is intuitively opened by the user is determined from the number of display pages and the number of content pages.

The third mode is the mode where, in the case where the page turning is performed in the page forward direction from the currently opened display page, the content which is displayed on the intuitively opened display page is determined from the current display page and content page, the number of remaining display pages, and the number of content pages.

The fourth mode is the mode where, in the case where the page turning is performed in the page backward direction from the currently opened display page, the content which is displayed on the intuitively opened display page is determined from the current display page and content page, the number of remaining display pages (number of display pages up to the newly opened display page), and the number of content pages.

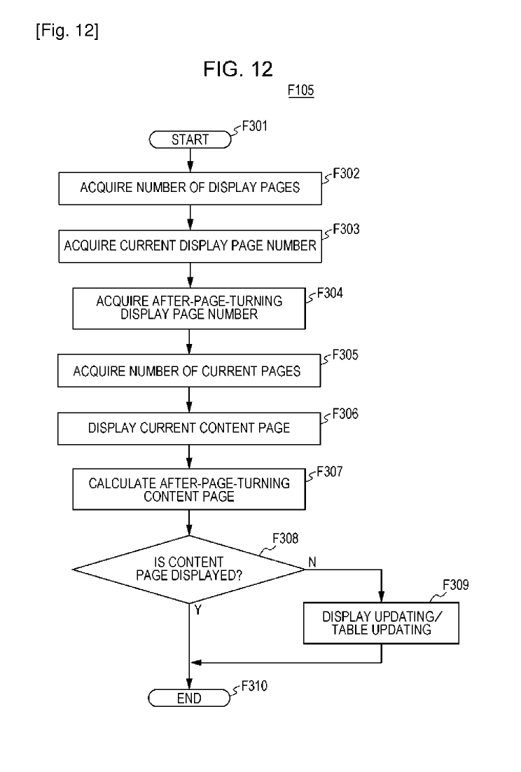

FIG. 12 illustrates an example of the display updating process performed in Step F105 of FIG. 9 when the page turning performed by the user is detected.

The controller 21 starts the display updating process in Step F301.

In Step F302, the controller 21 acquires the number of the display portions 6 (number of available display pages) attached to the electronic book 1. Similarly to Step F202 of FIG. 10, the number of the display pages is checked.

In Step F303, the controller 21 acquires the current display page number (e.g., the number of the currently opened display page) as a value which is used for the calculation. Herein, the acquired current display page number is the display page number of the display portion 6 which is viewed before the page turning is performed.

For example, when the user considers to view the display pages Disp1 and Disp2 in the facing state as illustrated in (b) of FIG. 11 and to view the display pages Disp27 and Disp28 in the facing state as illustrated in (d) of FIG. 11, first, the current display page numbers “1” and “2” are set as the value for the calculation.

In Step F304, the controller 21 acquires the after-page-turning display page number as the value used for the calculation. Herein, the acquired display number is the display page number of the display page which is viewed by the user after the page turning is performed. For example, in the case where the page turning is performed from the state of (b) of FIG. 8 to the state of (d) of FIG. 8 as described above, the after-page-turning display page numbers “27” and “28” are set as the values for the calculation.

In Step F305, the controller 21 acquires the number of available content pages as the value used for the calculation. Similarly to Step F203 of FIG. 10, the number of available content pages is the value which can be determined from the additional information or the like. For example, if the number of content pages=30, the controller 21 sets the number of content pages “30” as the value for the calculation.

In Step F306, the controller 21 acquires the value of the current content page as the value used for the calculation. This is the content page which is viewed by the user on the currently opened display page just before the page turning. The value of the content page can be obtained by referring to the display state management table. For example, as illustrated in (b) of FIG. 11, before the page turning, the user views the display pages Disp1 and Disp2, and the display state management table is in the state of (a) of FIG. 7. Therefore, it can be recognized from the display state management table that the values of the current (just before the page turning) content pages are “1” and “2”.

The controller 21 sets the current content pages “1” and “2” as the values for the calculation.

In Step F307, the controller 21 calculates the content page which is to be displayed after the page turning.

Herein, the controller 21 performs the calculation for determining the content page which is to be displayed on the after-page-turning display page by using the number of display pages, the current display page number, the after-page-turning display page number, the number of content pages, and the current content page which are set as the values for the calculation of Steps F302 to F306.

As the calculation process, the calculation of one of the aforementioned first to fourth modes is performed.
In addition, in the later-described calculation, one of the two pages which face each other may be used. For example, in the above example, if the even-numbered page is used for the calculation, the current display page number=“2”, the after-page-turning display page number=“28”, and the current content page=“2” may be applied to the later-described calculation equation.

By the calculation of one of the first mode to the fourth mode, if the content page displayed on the after-page-turning display page is determined, the controller 21 proceeds to Step F308. In Step F308, the controller 21 determines whether or not the determined content page is already displayed on the after-page-turning display page. This determination may also be performed by referring to the display state management table.

For example, it is considered that the user views the display pages Disp1 and Disp2 in the facing state as illustrated in (b) of FIG. 11 and the display pages Disp3 and Disp4 are in the facing state as illustrated in (c) of FIG. 11. In other words, this is the case where only one page is turned. At this time, in Step F307, the content pages displayed on the after-page-turning display pages Disp3 and Disp4 are determined to be “3” and “4”. In this case, in Step F308, the display state management table which is in the state of (a) of FIG. 7 is referred to. Therefore, it is written that the content pages “3” and “4” are already displayed on the display pages Disp3 and Disp4.

In this case, in Step F308, the controller 21 determines that the content page determined through the calculation is already displayed on the after-page-turning display page, and in this case, since the display control is particularly unnecessary, the process proceeds to Step F310, so that the display updating process is ended.

On the other hand, when the display state management table is in the state of (a) of FIG. 7, for example, the user allows the display pages Disp49 and Disp50 to be in the facing state, and as a result of the calculation of Step F307, it is determined that the content pages “239” and “240” are displayed.

In this case, if the display state management table is checked in Step F308, in the case of (a) of FIG. 7, “49” and “50” correspond to the display pages Disp49 and Disp50. In other words, it may be understood that the content pages “49” and “50” are the display state at the time (current time) just before the page turning.

In this case, the updating of the display detail is necessary.

Therefore, the controller 21 proceeds to Step F309 to perform the display updating control.

In other words, the display data generation unit 26 is commanded to display the content pages “239” and “240” with respect to the display pages Disp49 and Disp50.

Accordingly, the display data generation unit 26 performs the content page generation process. In other words, with respect to the display pages Disp49 and Disp50, the display data generation unit 26 reads the detail of the information of the designated content pages “239” and “240” from the high speed memory 22 or the non-volatile memory 23 and generates the display image (page data) thereof.

Next, the display data generation unit 26 supplies the generated page data to the display portion 6 as the after-page-turning display page N and performs the displaying. By doing so, for example, the content pages “239” and “240” are displayed on the display pages Disp49 and Disp50.

In addition, at this time, the controller 21 performs the updating of the display state management table. In other words, for example, if the display state management table is in the management state of (a) of FIG. 7, in response to the displaying of the content pages “239” and “240” on the display pages Disp49 and Disp50, the controller 21 updates the detail of the display state management table similarly to (b) of FIG. 7. In other words, the controller 21 updates the value of the content pages corresponding to the display pages Disp49 and Disp50 to “239” and “240”.

After that, the process of the controller 21 proceeds to Step F310, so that the display updating process is ended.

In addition, in the calculation of Step F307, the value of the to-be-displayed content page may be “0”, that is, the result indicating that no content is displayed may be obtained.

In this case, in the process of Step F308, it is checked based on the display state management table whether or not the value corresponding to the after-page-turning display page is “0”.

If the value is “0”, the process is ended in Step F310 as it is. If the value is not “0”, the display updating is performed in Step F309. In other words, in this case, the controller 21 transmits the command indicating that “no content is displayed” on the after-page-turning display page to the display data generation unit 26, so that the display in an empty page state is performed. In addition, the controller 21 updates the value of the content page corresponding to the after-page-turning display page to “0” in the display state management table.

Next, the display updating process is ended in Step F310.

### 3-3-1 First Mode

The calculation process of the first mode is described as the aforementioned calculation of FIG. 307.

The calculation of the first mode is a calculation of forwarding the content pages by the number of display pages which are simply turned.

Herein, for example, in the case where the number of display pages is 50 and the number of content pages is 30, as illustrated in (b) of FIG. 11, the state where the content pages “1” and “2” are displayed on the display pages Disp1 and Disp2 is considered. Herein, as illustrated in (d) of FIG. 11, the user opens the display pages Disp27 and Disp28. At this time, if the calculation is performed in the first mode, the calculation result indicating that the content pages displayed on the display pages Disp27 and Disp28 are “27” and “28” may be obtained.

In addition, as illustrated in (e) of FIG. 11, the display pages Disp35 and Disp36 are opened from the state of (b) of FIG. 11. At this time, if the calculation is performed in the first mode, the content pages displayed on the display pages Disp35 and Disp36 are “35” and “36”. However, since the number of content pages is “30”, the “35” and “36” do not exist. Therefore, the calculation result is obtained to be “0”.

The number of available content pages in the content unit is denoted by Ca; the number of the current (before-page-turning) content page is denoted by Cn; the number of available display pages is denoted by Da; the number of the currently opened display page is denoted by Dn; and the after-page-turning display page number is denoted by Dm.

Accordingly, the calculation of the first mode which calculates the after-page-turning content page Cm is as follows.

Cm=Dm−Dn+Cn

This can also be expressed as:

Cd=Dd

where Cd is the difference between Cm and Cn, and Dd is the difference between Dm and Dn.

However, when the calculation result Cm is larger than the number of content pages Ca, since no page exists, Cm=0.

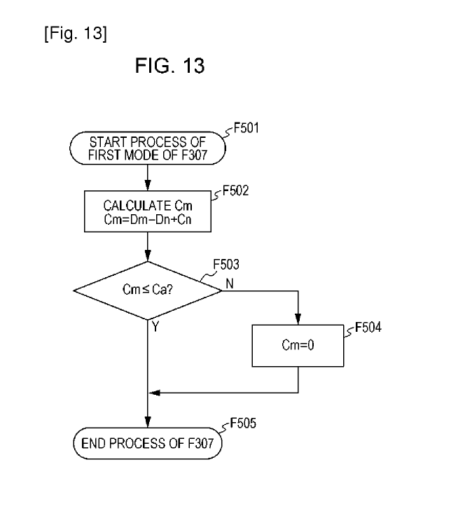

FIG. 13 illustrates the calculation process of the first mode. In the case where the first mode is selected in Step F104 of FIG. 9 and the process of FIG. 12 is performed as the display updating process of Step F105, the process of FIG. 13 is performed in Step F307.

The controller 21 starts the calculation of the first mode in Step F501.

In Step F502, the controller 21 calculates the after-page-turning content page Cm. In other words, the aforementioned calculation of Cm=Dm-Dn+Cn is performed.

In Step F503, the controller 21 determines whether or not the calculation result is

Cm≦the number of content pages Ca.

This is determination as to whether or not the after-page-turning content page exists by comparing the after-page-turning content page number with the number of content pages.

Herein, if it is determined that

Cm≦Ca,

the process is ended in Step F505. In this case, the controller 21 determines the content page Cm calculated in Step F502 as the after-page-turning content page.

If it is determined not to be

Cn≦Ca,

the controller 21 proceeds to Step F504. In Step F504, since the after-page-turning content page does not exist, the value of the after-page-turning content page Cm is updated to “0”. Next, the process is ended in Step F505.

In this case, the controller 21 determines that the content page Cm=0, in other words, that no content is displayed on the after-page-turning content page.

Several patterns in which actual values are assigned are described.

### Example 1

When the number of the display pages Da=50 and the number of content pages Ca=30, the content pages “1” and “2” are displayed in the state where the display pages Disp1 and Disp2 face each other.

At this time, with respect to the content pages displayed in the case where the display pages Disp15 and Disp16 are opened, since Cm=16−2+2=16, the content pages are “15” and “16”. Therefore, it is controlled in the state where the content pages “15” and “16” are displayed on the display pages Disp15 and Disp16.

### Example 2

When the number of the display pages Da=50 and the number of content pages Ca=30, the content pages “5” and “6” are displayed in the state where the display pages Disp5 and Disp6 face each other.

At this time, with respect to the content pages displayed in the case where the display pages Disp33 and Disp34 are opened, although Cm=34−6+6=34, since Ca=30, Cm=0 from Cm>Ca. As a result, no content page is displayed.

### Example 3

When the number of the display pages Da=50 and the number of content pages Ca=100, the content pages “53” and “54” are displayed in the state where the display pages Disp3 and Disp4 face each other.

At this time, with respect to the content pages displayed in the case where the display pages Disp21 and Disp22 are opened, Cm=22−4+54−2. For this reason, the content pages “71” and “72” are displayed on the display pages Disp21 and Disp22.

### Example 4

When the number of the display pages Da=50 and the number of content pages Ca=100, the content pages “71” and “72” are displayed in the state where the display pages Disp21 and Disp22 face each other.

At this time, with respect to the content pages displayed in the case where the display pages Disp3 and Disp4 are opened, Cm=4−22+72=54. For this reason, the content pages “53” and “54” are displayed on the display pages Disp3 and Disp4.

In this manner, in the process of the first mode, a content page having a value obtained by adding or subtracting the number of the display page turnings to or from the value of the content page which is displayed on the display page, which is in the opened state, is calculated. In this process, this is determined as the content page which is to be displayed on the display page which is next in the opened state.

### 3-3-2 Second Mode

As the aforementioned calculation of Step F307, the calculation process of the second mode is described.

The calculation of the second mode is calculation of determining the content page, which is to be displayed on the display page which is intuitively opened by the user, from the number of display pages and the number of content pages.

More specifically, the after-page-turning content page Cm is displayed on the after-page-turning display page Dm from the ratio between the number of display pages Da and the number of content pages Ca.

Da:Ca=Dm:Cm

For the above equation, the after-page-turning content page Cm may be expressed as follows.

Cm=Dm−Ca/Da

In the example case in which the electronic book is closed before the page turning, the currently opened display page can be represented as Dn=0, and the current content page can be represented as Cn=0. The above equation can then also be expressed as:

Cd:Ca=Dd:Da

where Cd is the difference between Cm and Cn=0, and Dd is the difference between Dm and Dn=0.

In the case in which the electronic book is closed before the page turning, Ca may also represent the number Cr of content pages between the current content page Cn=0 and the other end of the available content pages, and Da may also represent the number Dr of display pages between the currently opened display page Dn=0 and the other end of the available display pages. The above equation can then also be expressed as:

Cd:Cr=Dd:Dr

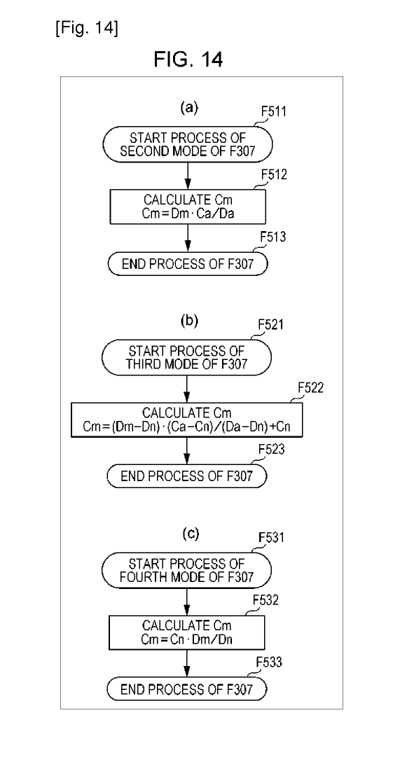

(a) of FIG. 14 illustrates a calculation process of the second mode. In the case where the second mode is selected in Step F104 of FIG. 9 and the process of FIG. 12 is performed as the display updating process of Step F105, the process of (a) of FIG. 14 is performed in Step F307.

The controller 21 starts the calculation of the second mode in Step F511.
In Step F512, the controller 21 calculates the after-page-turning content page Cm. In other words, the controller 21 performs the above calculation of

Cm=Dm−Ca/Da.

In Step F513, the controller 21 ends the process.

Several patterns in which actual values are assigned are described.

### Example 1

When the number of the display pages Da=50 and the number of content pages Ca=30, as illustrated in (a) and (f) of FIG. 11, the electronic book 1 is in the closed state.

If the display pages Disp11 and Disp12 are opened from this state to the facing state, since the displayed content pages

Cm=12×30/50=7,

the content pages “6” and “7” are displayed.

### Example 2

When the number of the display pages Da=50 and the number of content pages Ca=100, as illustrated in (a) and (f) of FIG. 11, the electronic book 1 is in the closed state.

If the display pages Disp21 and Disp22 are opened from this state to the facing state, since the displayed content pages

Cm=22×100/50=44,

the content pages “43” and “44” are displayed.

In this manner, in the calculation of the second mode, the controller 21 sets the number of display portions 6 (Da) as the value of the number of target display portions.

In addition, the controller 21 sets the number of pages of the content data (Ca) as the value of the number of target content pages.

In addition, the controller 21 sets the value (Dm) of the display page of the display portion 6 which is changed from the current state to the next opened state as the page difference value.

In addition, the content page (Cm) of which the ratio of the number of target content pages (Ca) is equal to the ratio of the page difference value (Dm) to the number of target display portions (Da) is calculated, and the content page (Cm) is determined as the content page which is to be displayed on the display page which is next in the opened state.

### 3-3-3 Third Mode

As the aforementioned calculation of Step F307, the calculation process of the third mode is described.

The calculation of the third mode is calculation of determining the content page, which is to be displayed on the display page which is intuitively opened in the page forward direction by the user, from the currently opened display page number and content page number, the number of remaining display pages, and the number of content pages. In other words, in the third mode, the content page is calculated based on the currently opened display page and content page, the number of remaining displays in the page forward direction, and the relationship of the ratio between the number of remaining content pages and the number of displays turned in the page forward direction.

For example, it is considered that contents of 1000 pages are loaded on the electronic book 1 having 100 display pages and the display page Disp50 is opened and the content page “50” is read. At this time, the number of the remaining display portions 6 is 50, and the number of the remaining content pages is 950.

In this state, if the 25th remaining display portion 6 is opened among the 50 remaining display portions 6, the 525th page which is the middle of the 950 remaining content pages and which is forwarded by 475 pages is displayed thereon.

The number of remaining display pages is expressed by Dr=Da−Dn based on the number of display pages Da and the current display page number Dn. Dr thus represents the number of display pages between the currently opened display page Dn and the end of the available display pages.

In addition, the number of remaining content pages is expressed by Cr=Ca−Cn based on the number of content pages Ca and the current content page number Cn. Cr thus represents the number of content pages between the current content page Cn and the end of the available content pages.

Herein, if the page turning is performed up to the display page number Dm, the number of forwarding pages Cx of the content pages is as follows.

Da−Dn:Ca−Cn=Dm−Dn:Cx

Cx=(Dm−Dn)−(Ca−Cn)/(Da−Dn)

As a result, when the page turning is performed up to the display page number Dm, the content page Cm displayed can be expressed as follows.

Cm=(Dm=Dn)−(Ca−Cn)/(Da−Dn)+Cn(herein, Dm≧Dn)

which can also be expressed as:

Cd:Cr=Dd:Dr

where Cd is the difference between Cm and Cn, and Dd is the difference between Dm and Dn.

(b) of FIG. 14 illustrates a calculation process of the third mode. In the case where the third mode is selected in Step F104 of FIG. 9 and the process of FIG. 12 is performed as the display updating process of Step F105, the process (b) of FIG. 14 is performed in Step F307.

The controller 21 starts the calculation of the third mode in Step F521.
In Step F522, the controller 21 calculates the after-page-turning content page Cm. In other words, the controller 21 performs the aforementioned calculation of

Cm=(Dm−Dn)−(Ca−Cn)/(Da−Dn)+Cn.

In Step F523, the controller 21 ends the process.

Several patterns in which actual values are assigned are described.

### Example 1

When the number of display pages Da=100 and the number of content pages Ca=1000, the content pages “49” and “50” are displayed in the state where the display pages Disp49 and Disp50 face each other.

At this time, with respect to the content pages Cm displayed in the case where the display pages Disp79 and Disp80 are opened,

Cm=(80−50)×(1000−50)/(100−50)+50=620.

Therefore, the content pages “619” and “620” are displayed.

### Example 2

When the number of display pages Da=100 and the number of content pages Ca=1000, the content pages “321” and “322” are displayed in the state where the display pages Disp21 and Disp22 face each other.

At this time, with respect to the content pages Cm displayed in the case where the display pages Disp89 and Disp90 are opened,

Cm=(90−22)×(1000−322)/(100−22)+322=913.

Therefore, the content pages “912” and “913” are displayed.

In this manner, in the third mode, the controller 21 sets the number of display portions 6 (Da−Dn) in the page forward direction as viewed from the display portion 6 which is currently in the opened state as the value of the number of target display portions.

In addition, the controller 21 sets the number of remaining pages (Ca−Cn) up to the last page of the content data as viewed from the current content data page which is displayed on the display portion 6 which is currently in the opened state as the number of target content pages.

In addition, the controller 21 sets the difference value (Dm-Dn) of the display portion page from the display portion 6 which is currently in the opened state to the display portion 6 which is next in the opened state as the page difference value.

Next, the number of content pages (Cx) of which the ratio to the number of target content pages (Da−Dn) is equal to the ratio of the page difference value (Dm−Dn) to the number of target display portions (Da−Dn) is calculated. Next, the content page which is to be displayed on the display page which is next in the opened state (Cm) is determined based on the above the number of content pages (Cx).

### 3-3-4 Fourth Mode

As the aforementioned calculation of Step F307, the calculation process of the fourth mode is described.

The calculation of the fourth mode is calculation of determining the content page, which is to be displayed on the display page which is intuitively opened by the user in the page backward direction, from the currently opened display page number and content page number, the number of remaining display pages, and the number of content pages.

In other words, in the fourth mode, the content page is calculated based on the currently opened display page and content page and the relationship of the ratio between the number of displays which are turned in the page backward direction.

For example, contents of 1000 pages are loaded on the electronic book 1 having 100 the display pages, and the user opens the display page Disp30 and reads the content page “330”. At this time, if the user opens the display page Disp15 which is the center of the display pages up to the display page Disp30, the 165th page which is the center as viewed from the current content page “330” is displayed thereon.

The relationship between the after-page-turning display page number Dm and the after-page-turning content page number Cm can be expressed from the current display page number Dn and the current content page number Cn as follows.

(c) of FIG. 14 illustrates the calculation process of the fourth mode. In the case where the fourth mode is selected in Step F104 of FIG. 9 and the process of FIG. 12 is performed as the display updating process of Step F105, the process of (c) of FIG. 14 is performed in Step F307.

The controller 21 starts the calculation of the fourth mode in Step F531.

In Step F532, the controller 21 calculates the after-page-turning content page Cm. In other words, the above-described calculation of

Cm=Cn−Dm/Dn

is performed. This can also be expressed as:

Cd:Cr=Dd:Dr

where Cd is the difference between Cm and Cn, Cr is the number of content pages between the current content page Cn and the beginning of the available content pages, Dd is the difference between Dm and Dn, and Dr is the number of display pages between the currently opened display page Dn and the beginning of the available display pages.

In Step F533, the controller 21 ends the process.

Several patterns in which actual values are assigned are described.

### Example 1

The content pages “349” and “350” are displayed in the state where the display pages Disp49 and Disp50 face each other.

At this time, with respect to the content pages Cm displayed in the case where the display pages Disp19 and Disp20 are opened,

Cm=0350×20/50=140.

By doing so, the content pages “139” and “140” are displayed.

### Example 2

The content pages “897” and “898” are displayed in the state where the display pages Disp97 and Disp98 face each other.

At this time, with respect to the content pages Cm displayed in the case where the display pages Disp19 and Disp20 are opened,

Cm=898×20/98=183.

Therefore, the content pages “182” and “183” are displayed.

In this manner, in the calculation of the fourth mode, the controller 21 sets the number of display portions 6 (Dn) in the page backward direction as viewed from the display portion 6 which is currently in the opened state as the value of the number of target display portions.

In addition, the controller 21 sets the number of pages (Cn) from the leading page of the content data to the page of the current content data, which are displayed on the display portion 6 which is currently in the opened state, as the number of target content pages.

In addition, the controller 21 sets the value (Dm) of the display page of the display portion 6, which is changed from the current state to the next opened state, as the page difference value.

Next, the content page (Cm) of which the ratio to the number of target content pages (Cn) is equal to the ratio of the page difference value (Dm) to the number of target display portions (Dn) is calculated, and the content page (Cm) is determined as the content page which is to be displayed on the display page which is next in the opened state.

### 3-3-5 Other Examples

In the examples of the calculations of the first to fourth modes hereinbefore, the calculation is performed based on the facing opened right display portion 6 (even-numbered page) and the −1 operation is performed on the result, so that the content page displayed on the left display portion 6 (odd-numbered page) is calculated. On the contrary, it may be configured that the calculation is performed based on the left display portion 6 and the +1 operation is performed on the result thereof, so that the content page displayed on the right display portion 6 is calculated.

In the examples of the calculations of the first to fourth modes, the calculation is performed based on the facing opened right display portion 6 (even-numbered page) and the −1 operation is performed on the result thereof, so that the content page displayed on the left display portion 6 (odd-numbered page) is calculated. On the contrary, with respect to the left display portion 6, the to-be-displayed content page may be obtained through the same independent calculation as that of the right display portion 6.

However, in this case, when there is a great difference between the number of displays and the number of content pages, the facing consecutive pages may not be viewed. For example, the facing left page becomes the 33rd page, and the right page becomes the 36th page. In this case, it is preferable that the correction of the calculation result be performed so that the consecutive pages are retained.

In the examples of the calculations of the first to fourth modes, although the value obtained through the calculation equation is gently set to the to-be-displayed content page, for example, the calculation result may be adjusted so that the left sides always become the odd-numbered pages.

For example, the content pages displayed on the left display portions 6 are always defined as the odd-numbered pages. In addition, in the case where it is obtained that the content page of the facing left display portion 6 is the even-numbered page “6”, it may be configured so that the −1 or +1 content page is displayed.

Similarly, the pages displayed on the left display portions 6 are always defined as the even-numbered pages, and it may be configured so that the −1 or +1 content page is displayed thereon.

In addition, reversely, the left display portions 6 may always be defined as the odd-numbered pages, and the right display portions 6 may always be defined as the even-numbered pages.

Besides the examples of the calculations of the first to fourth modes, calculation methods of calculating the after-page-turning content page by using one of or a plurality of the number of content pages, the current content page, the number of display pages, the current display page number, and the after-page-turning display page number may also be perform.

### 3-4: Updating Mode Selecting Process

An example of the aforementioned updating mode selection process of selecting the updating mode is described. In other words, an example of the process performed in Step F104 of FIG. 9 is described.

The updating mode selection process according to the embodiment is the process of determining whether or not the value of the difference in number of display pages from the current state to the display portion 6 which is next in the opened state is equal to or larger than a predetermined number (e.g., whether Dd is equal to or larger than a predetermined threshold) and selecting the updating mode.
Hereinafter, although the examples I to III of the updating mode selecting process are described, in these process, the number of display pages, which number of display pages are turned from the current display page and the after-page-turning display page, which position in the vicinity of which of the all the display pages of the electronic book 1 the display page is turned, or the like is determined. Therefore, the optimal updating mode is selected by this pattern, so that it is possible to implement the intuitive page turning by the user like a real book.

For example, in the following state, the updating mode is selected.

In the case where a small number of pages (about one through five pages) are turned, the first mode is set.

In the first mode, it is possible to securely perform the page turning like a real book when a small number of pages are turned so that a person can recognize the number of turned pages.

In the case where the display page at a rough position is opened from some state (for example, a closed state), the second mode is set. In this case, as a display suitable for intuitive page turning, it is possible to performing opening of the front side of the content, opening of the rear side, opening of the central portion, or the like.

In addition, in the case where the user desires to open the last display page abruptly, when the number of display pages<the number of content pages in the updating of the first mode, since the last content page is not displayed, the page cannot be opened. However, if the second mode is used, when the last display page is opened, the last content page is displayed.

In addition, in the case where the user desires to open the last page abruptly, when the number of display pages>the number of content pages in the first mode, the content page is not displayed on the last display page, and it is difficult to determine which position is the last content page and to intuitively open the position. However, if the second mode is used, when the last display page is opened, the last content page is displayed.

In addition, in the some display page is opened and, during the viewing of a content page, the multi-page turning is performed, the third mode and the fourth mode are set.

This is effective when the user desires to roughly view the preceding or following content during the viewing of a page. By using this method, it is possible to perform roughly checking the pages while performing turning a lump of pages.

### 3-4-1 Example I of Process

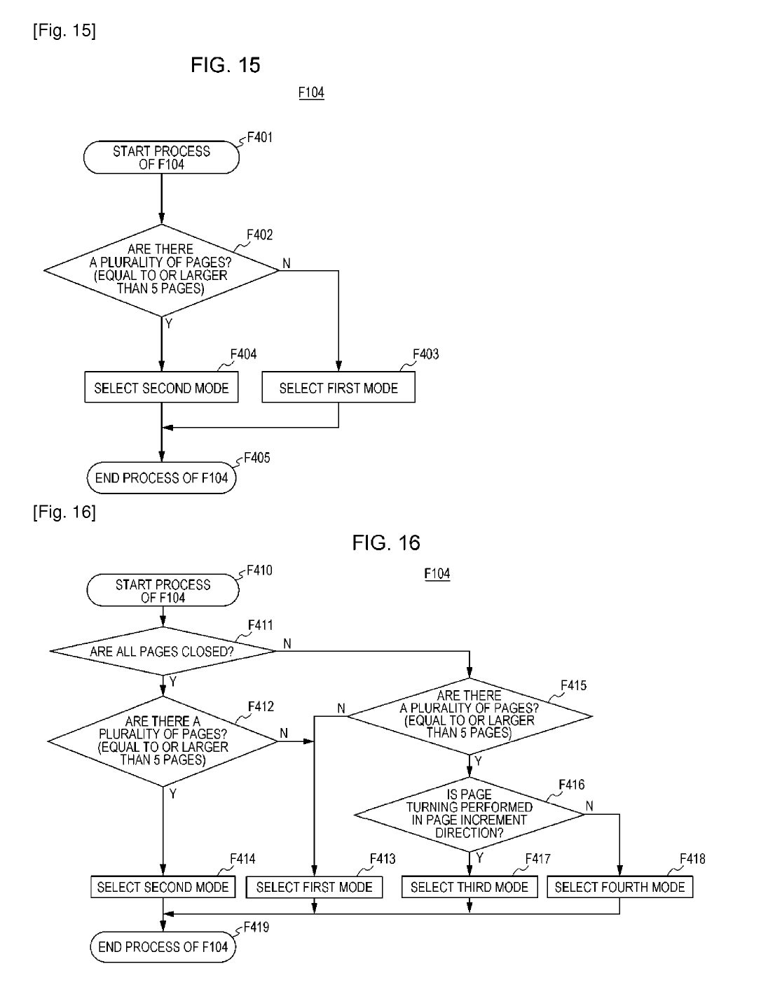

FIG. 15 illustrates an example I of the updating mode selection process. This is an example where one of the aforementioned first and second modes is selected.

The controller 21 starts the updating mode selection process of Step F104 of FIG. 9 in Step F401 of FIG. 15.

As described with reference to FIG. 9, the updating mode selection process of Step F104 is performed in the case where the page turning is performed.

In the process of FIG. 15, in Step F402, the controller 21 determines whether or not the page turning of this time is multi-page turning. As an example, the multi-page turning is the case where five or more display pages are turned at one time.

The controller 21 may determine whether or not the page turning is the multi-page turning of five or more pages by checking the difference in number between the display page which is currently (just before the page turning) in the opened state and the display page which is in the opened state after the page turning.

In the case where the page turning is not the multi-page turning, for example, in the case where the page turning is the page turning of 1 to 4 display pages, the controller 21 proceeds to Step F403 to select the first mode. In addition, in the case where the two front and back surfaces of the sheet 2 are the display portions 6, the page turning of 1 to 4 display pages is the page turning of one page or two pages in terms of the sheet 2.

On the other hand, in the case where the controller 21 determines the multi-page turning, the process proceeds to Step F404, so that the second mode is selected.

In this manner, if the updating mode selection is performed, the updating mode selection process (F104) is ended in Step F405.

Therefore, according to the process example I, when the user performs the page turning of five or more pages, the second mode is selected, and the display control according to the intuitive page turning of the user is performed by the calculation of (a) of FIG. 14 as the display updating process of the next Step F105.

On the other hand, if the user performs the page turning of four or less pages, the display updating control is performed according to the number of pages in the process of FIG. 13 as the first mode.

### 3-4-2 Process Example II

The process example II of the updating mode selecting is described with reference to FIG. 16. This is an example of selecting one of the aforementioned first to fourth modes.

The controller 21 starts the updating mode selecting process of Step F104 of FIG. 9 in Step F410 of FIG. 16.

In Step F411, the controller 21 determines whether or not all the current (just before page turning) display pages are in the closed state.

For example, (a) and (f) of FIG. 11 illustrate the states where all the display pages are closed.

If it is determined that all the display pages are closed, the controller 21 proceeds to Step F412. On the other hand, if it is determined that any of the display pages is opened, the controller 21 proceeds to Step F415.

In the case where the display pages are currently in the closed state, in Step F412, the controller 21 determines, for example, whether or not the page turning is the multi-page turning of which the number of the page turnings is 5 pages or more.

If the page turning is determined to be the multi-page turning, the controller 21 proceeds to Step F414, so that the second mode is selected as the updating mode, and the updating mode selecting process (F104) is ended in Step F419.

If it is determined not to be the multi-page turning (less than 5 pages), the controller 21 proceeds to Step F413. Next, as the updating mode, the first mode is selected, and the updating mode selection process (F104) is ended in Step F419.

In the case where any of the display pages is opened currently, the controller 21 determines through Step F415 whether or not the multi-page turning exists.

If it is determined not to be the multi-page turning (less than 5 pages), the controller 21 proceeds to Step F413, so that as the updating mode, the first mode is selected, and the updating mode selection process (F104) is ended in Step F419.

If it is determined to be the multi-page turning in Step F415, the controller 21 determines the page turning direction in Step F416. In other words, the display page which is to be next opened and the current display page are compared in the magnitude of page number.

If the page turning direction is the page forward direction, the controller 21 proceeds to Step F417 to select the third mode as the updating mode and ends the updating mode selection process (F104) in Step F419.

If the page turning direction is the page backward direction, the controller 21 proceeds to Step F418 to select the fourth mode as the updating mode and ends the updating mode selection process (F104) in Step F419.

Therefore, according to the process example II, when the user performs the page turning of five or more pages, one of the second mode through the fourth mode is selected, and the display control according to the intuitive page turning of the user is performed by the calculation in one of (a), (b), and (c) of FIG. 14 as the display updating process of the next Step F105.

In other words, in the case where the electronic book 1 is opened from the closed state, the second mode is set; in the case where the page turning is performed from the opened state in the forward direction, the third mode is set; and in the case where the page turning is performed from the opened state in the backward direction, the fourth mode is set.

On the other hand, if the user performs the page turning of four or less pages, the display updating control is performed according to the number of pages in the process of FIG. 13 as the first mode.

### 3-4-3 Process Example III

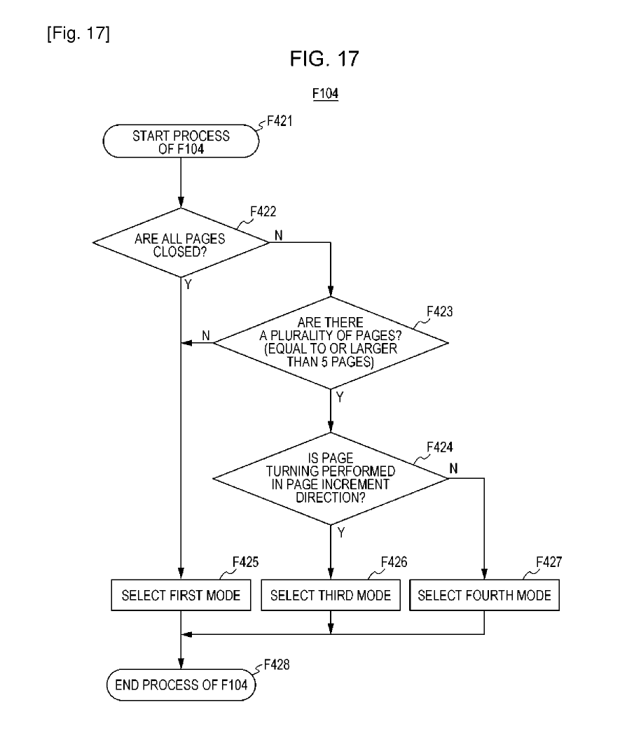

The process example III of the updating mode selection is described with reference to FIG. 17. This is an example of selecting one of the aforementioned first, third, and fourth modes.

The controller 21 starts the updating mode selection process of Step F104 in FIG. 9 through Step F421 in FIG. 17.

The controller 21 determines through Step F422 whether or not all the display pages are in the closed state currently (just before the page turning).

If it is determined that all the display pages are closed, the controller 21 proceeds to Step F425. On the other hand, if it is determined that any of the display pages is opened, the controller 21 proceeds to Step F423.

In the case where the display page is currently in the closed state, the controller 21 selects the first mode as the updating mode in Step F425 and ends the updating mode selection process (F104) in Step F428.

In the case where some of the display pages are currently opened, in Step F423, the controller 21 determines whether or not it is the multi-page turning. If it is determined not to be the multi-page turning, the controller 21 proceeds to Step F425 to select the first mode as the updating mode and ends the updating mode selection process (F104) in Step F428.

If it is determined to be the multi-page turning in Step F423, the controller 21 determines the page turning direction in Step F424. In other words, the display page which is to be next opened and the current display page are compared with each other in terms of the magnitude of page number.

If the page turning direction is the page forward direction, the controller 21 proceeds to Step F426 to select the third mode as the updating mode and ends the updating mode selection process (F104) in Step F428.

If the page turning direction is the page backward direction, the controller 21 proceeds to Step F427 to select the fourth mode as the updating mode and the updating mode selection process (F104) in Step F428.

Therefore, according to the process example III, when the user performs the page turning of five or more pages from the opened state, one of the third mode and the fourth mode is selected, and the display control according to the intuitive page turning of the user is performed by the calculation in one of (b) and (c) of FIG. 14 as the display updating process of the next Step F105.

On the other hand, if the user performs the page turning of four or less pages, in the case where the electronic book 1 is opened from the closed state, the display control is performed according to the number of pages in the process of FIG. 13 as the first mode.

### 3-5: Summary of Updating Mode Selection and Display Updating Process

In the embodiment, similarly to the aforementioned examples, the updating mode selecting process and the display updating process are performed.

In other words, the updating mode selecting is performed according the condition as to whether the state just before the page turning is the closed state or the opened state or the condition of the number of turned pages (whether or not the page turning is the multi-page turning).

For example, when the number of the page turnings from the current state to the display portion 6 which is next in the opened state is equal to or larger than a predetermined number, the second mode, the third mode, or the fourth mode is selected as the updating mode.

In this case, the content page which is to be displayed on the display portion 6 which is next in the opened state is determined through the calculation using the number of target display portions, the number of target content pages, and the page difference value.

On the other hand, when the number of the page turnings from the current state to the display portion 6 which is next in the opened state is smaller than the predetermined number, as the first mode, the content page having a value obtained by adding or subtracting the number of the page turnings to or from the value of the content page which is displayed on the display portion 6 which is currently in the opened state is calculated, and the content page which is to be displayed on the display portion 6 which is next in the opened state is determined.

When the display portion 6 which is next in the opened state is detected, the controller 21 performs the calculation for determining the content page based on the detection information from the sensor unit 28 and performs control of displaying the content page on the display portion 6 which is next in the opened state.

In the electronic book 1 according to the embodiment, the following advantages may be obtained.

First, when the number of display pages is smaller than the number of content pages, the displayed content page is selected through the calculation based on the relationship among the number of display pages, the currently opened and viewed display page, the number of remaining display pages, the number of all the content pages, the currently viewed content page, and the amount of the remaining content items. In other words, the content page suitable for the display page which is intuitively opened by the user is calculated, and the content page is displayed on the display page which is next opened. By doing so, like a real book, the pages of which the number is equal to or larger than the number of the display portions 6 can be intuitively skipped.

In addition, when the number of display pages is smaller than the number of content pages, the content page which is displayed on the display page which is next opened is selected through the calculation based on the relationship among the number of all the display pages, the currently opened and viewed display page, the number of remaining display pages, the number of all the content pages, the currently viewed content page, and the amount of the remaining content items.

Therefore, the user can check the page, which is separated by the number of display pages or more, and the current page in the content at the same time.

In addition, when the number of display pages is larger than the number of content pages, since a middle page becomes the last page, there is a problem in that it is necessary to search for the middle page in order to intuitively open the vicinity of the last page.

However, the position of the content which is to be displayed at the display position which is intuitively opened is calculated from the relationship among the number of display pages, the currently opened and viewed display page, the number of remaining display pages, the number of all the content pages, the currently viewed content page, and the amount of remaining content items, so that it is possible to intuitively view the rear-side pages.

### 4. Display Control Process for Performing Predictive Updating

The aforementioned embodiment is an example where it is considered that the updating of the display content page of each of the display portions 6 is performed at the moment when the next display portion 6 is opened by the page turning.

As an actual implementation, for example, in the case of a structure where a display control circuit system illustrated in FIG. 5 is disposed in the book spine 5 and display data are transmitted from an inner portion of the book spine 5 to the opened display portion 6, as the data amount of the display data are increased, the transmission rate may be decreased. In this case, a phenomenon where the content page is not displayed although some display portion 6 is opened may occur.

Therefore, it may be configured so that the content page which is displayed in the closed state on the display page which is set in advance, is calculated and displayed.

In other words, sequentially in the time interval when the display portion 6 which is next in the opened state is not detected, the controller 21 determines the content page which is to be displayed on each of the display portions 6 and performs control of displaying the content page on each of the display portions 6 by the calculation of the first to fourth modes based on the detection information from the sensor unit 28.

For example, it is considered that the content pages “21” and “22” are viewed by the display pages Disp21 and Disp22.

In this case, with respect to the pages near the current display pages Disp21 and Disp22, for example, the display pages Disp15 to Disp28, the content page calculated through the algorithm of the first mode is displayed. For example, the page is the display page which is not subject to the “multi-page turning”.

On the other hand, with respect to the display page which is prior to the display page Disp29, the content page calculated through the algorithm of the third mode is displayed.

In addition, with respect to the display page which is prior to the display page Disp14, the content page calculated through the algorithm of the fourth mode is displayed.

If this process (the predictive display updating) is performed before the next page turning by the user, the user can view the content page as soon as the user opens this.

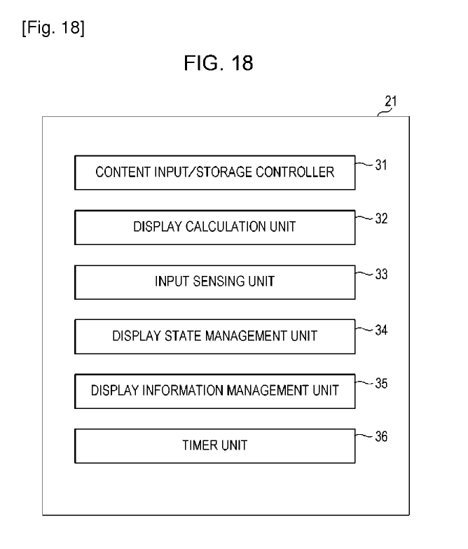

The configuration and the process of this case are described with reference to FIGS. 18 to 20.

FIG. 18 illustrates a functional configuration of the controller 21. FIG. 18 is different from FIG. 6 in that a timer unit 36 is installed. The timer unit 36 is a timer function for acquiring a timing of performing the predictive updating process as an interrupt process.

Since the other functional blocks are the same as those of FIG. 6, the description thereof is omitted.

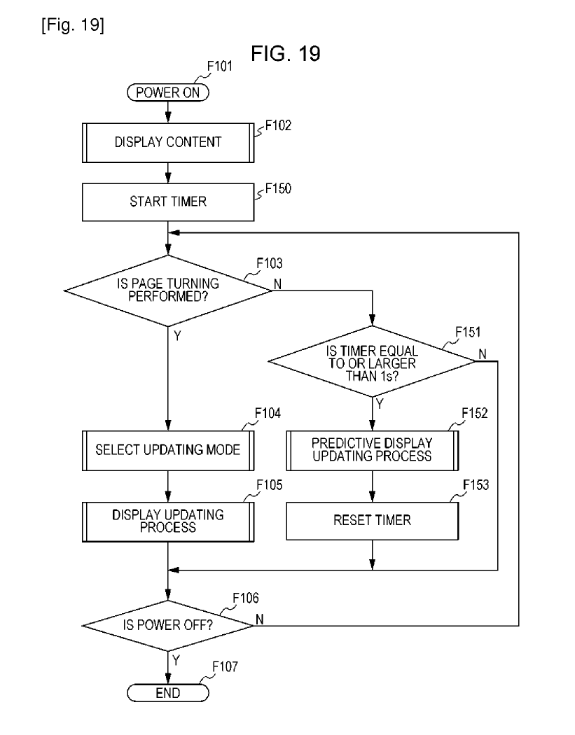

FIG. 19 illustrates the processes of the controller 21 from the power-on to the power-off. In addition, the same steps as those of FIG. 9 are denoted by the same step reference numerals, and the redundant detailed description is omitted.

If the power is turned on Step F101 and the content display (initial display) is performed in Step F102, the controller 21 starts time counting by the timer unit 36 in Step F150.

After that, like the aforementioned embodiment, the page turning is monitored in Step F103, and in the page turning is performed, the updating mode selecting is performed in Step F104, and the display updating process is performed in Step F105.

In the example of the process of FIG. 19, in the time interval when the page turning is not performed, the processes of Steps F151 to F153 are performed.

In other words, in Step F151, the controller 21 checks a count value of the timer unit 36. For example, after elapse of every period of 1 sec in the value of the time, the controller 21 performs a predictive display updating process of Step F152.

In the case where the predictive display updating process is performed, in Step F153, the value of the timer is reset, and the timer is started.

By the process of FIG. 19, during the time interval when the page turning is not performed, the predictive display updating process is performed every about 1 sec.

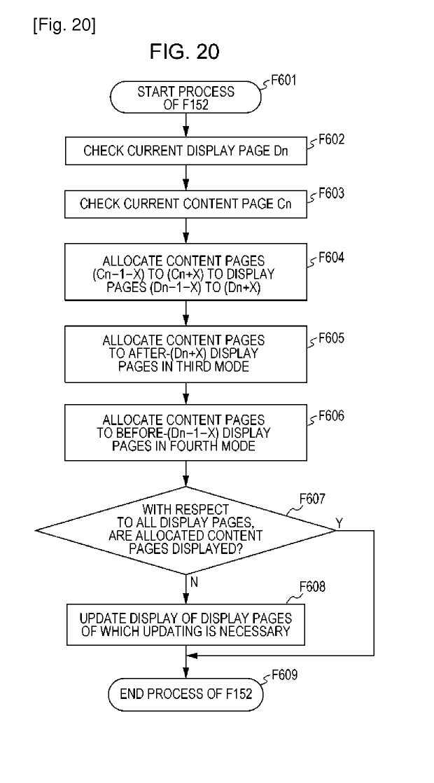

Details of the predictive display updating process performed by the controller 21 in Step F152 are illustrated in FIG. 20.

If the controller 21 starts the predictive display updating process in Step F601, the controller 21 first checks the display page (Dn) which is currently opened in Step F602. This is the display page checked by the display information management unit 35 at this time.

Next, in Step F602, the controller 21 checks the content page (Cn) displayed on the display page (Dn) which is currently opened. This may be checked from the display state management table.

In Step F604, the controller 21 first allocates the to-be-displayed content page to the display pages (Dn−1−X) to (Dn+X) in the vicinity of the current display page Dn. The allocation is performed by the calculation of the first mode.

For example, by considering that the content pages “21” and “22” are viewed by the display pages Disp21 and Disp22, it is set so that X=6.

The current display page Dn is set so that the facing right-side even-numbered page=Disp22.

Accordingly, the display pages (Dn−1−X) to (Dn+X) become the display pages Disp15 to Disp28.

Through the calculation of the first mode, the content pages “15” to “28” are allocated to the display pages Disp15 to Disp28.

Next, in Step F605, the controller 21 performs the allocation of the to-be-displayed content pages to the display pages after the display page (Dn+X) through the calculation of the third mode.

In the case of the aforementioned example, the content pages Cm obtained by the calculation of the following equation are allocated to the display pages from the display page Disp29 to the last display page.

Cm=(Dm−Dn)−(Ca−Cn)/(Da−Dn)+Cn

Next, in Step F606, the controller 21 performs the allocation of the to-be-displayed content pages to the display pages before the display page (Dn-1-X) through the calculation of the fourth mode.

In the case of the above example, the content pages Cm obtained by the calculation of the following equation are allocated to the display pages subsequent to Disp1 to Disp14.

Cm=Cn−Dm/Dn

In this manner, if the content pages are allocated to all the display pages, in Step F607, the allocation states and the actual display states are checked. In other words, with respect to all the display pages, it is checked whether or not the currently allocated content pages are in the displayed states.

The result of the allocation may be compared with the detail of the display state management table.

In other words, with respect to all the display pages, if the content pages allocated at this time are in the display state, it is not necessary to perform the updating, the predictive display updating process is ended in Step F609.

On the other hand, in the case where the display page of which the display detail is different from that of the content page allocated at this time exists, the display updating control is performed on the display page. In other words, the display data generation unit 26 is commanded to perform the display of the content page allocated at this time on the corresponding display page.

If the display updating control is performed, the controller 21 ends the predictive display updating process in Step F609.

For example, the predictive display updating process is sequentially performed, so that the display corresponding to the intuitive page turning of the user is performed in advance.

### 5. Display Updating Process for Performing Content Page Adjustment

In the description of the embodiment hereinbefore, as the display corresponding to the intuitive page turning of the user, the content page which is to be displayed on the after-page-turning display page is determined from the result of the calculation of the second to fourth modes.

However, by considering the convenience of the user, the content page of the calculation result may be adjusted.

First, it is considered that the index page information exists as the additional information of the content data.

The index page information is information indicating the page which becomes the index point of the details of the content (the portion partitioning the details).

For example, the index page information is information of the leading page which is the portion of partitioning the details such as sections, chapters, and the like of a novel, an article, or the like, portions of partitioning date (partitioning portions of weeks or months) of a diary, an album, or the like.

Among all the pages of the content data, some content pages are designated as the index pages in advance.

The controller 21 recognizes the index page information by a function of the content input/storage controller 31 of FIG. 6 or 18.

In addition, with respect to the index page, the format or the like of the content data is analyzed, so that the controller 21 may automatically set the index page. Alternatively, the index page may be designated and input by the user.

In the case where the book is intuitively opened or the multi-page turning is performed by the user, it is convenient that, after the page turning is performed, the user can view the index page.

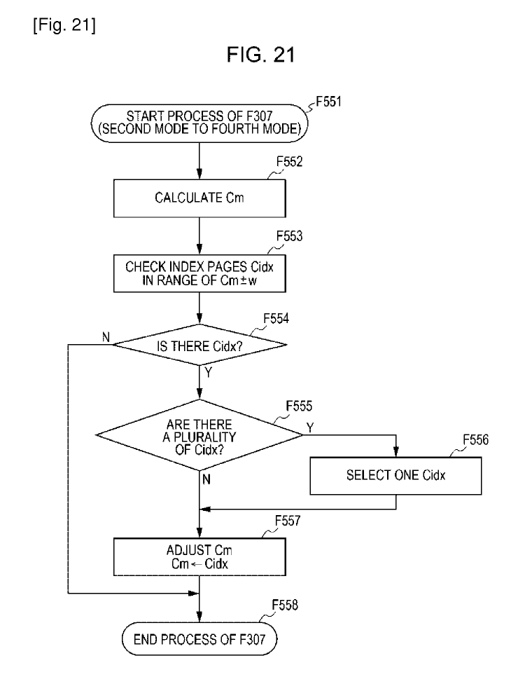

Therefore, in Step F307 of FIG. 12, in the case where one of the calculations of the second to fourth modes is performed, for example, the same process as that of FIG. 21 is configured to be performed.

In Step F551, the controller 21 starts the process of Step F307 of FIG. 12.

In Step F552, the controller 21 calculates the content page Cm displayed on the display page which is next in the opened state through the calculation of the updating mode selected among the second mode through the fourth mode. In other words, one of the processes of (a), (b), and (c) of FIG. 14 is performed.

At this time, although the displayed content page is obtained, the controller 21 performs adjustment of the result of the calculation by the following process. First, in Step F553, the controller 21 checks whether or not the index page Cidx exists in the vicinity

(the range of ±w pages)

of the obtained content page Cm. For example, it is set that w=10 pages or the like. Alternatively, the number of pages of the content data may be set to the number of pages having a predetermined

% pages.

If the index page Cidx does not exist, the process proceeds from Step F554 to F558, and the process of Step F307 is ended. In this case, the content page Cm calculated in Step F552 is determined as the display content page as it is.

On the other hand, if the index page Cidx exits in the vicinity of the obtained content page Cm, the process proceeds from Step F554 to Step F555, so that the controller 21 checks whether or not a plurality of the index pages Cidx exist.

In the case where a plurality of the index pages Cidx exist, the controller 21 selects one index page Cidx in Step F556. For example, the controller 21 selects the index page Cidx which is a page near the content page Cm. Alternatively, a prior page or a posterior page, or the like may be selected.

In the case where one index page Cidx exists and the case where one is selected among a plurality of the index pages Cidx, the controller 21 corrects the content page Cm of the calculation result to the page number of the index page Cidx in Step F557.

Next, the process is ended in Step F558.

If the same process as that FIG. 21 is performed in Step F307 of FIG. 12, when the user opens intuitively a page, it is possible to increase the probability of the page becomes the leading page of some chapter of the content data or the like. Therefore, the user can find the position of the details of the intuitively opened page, so that it is possible to easily find the desired portion.

### 6. Modified Example

Hereinbefore, although the configurations of the embodiments or the process of the processes are described, various modified examples may be considered.

In the embodiment, although it is described that the ordinary display is also performed with respect to the closed display portion 6, it may be configured so that the display is performed only with respect to the opened display page.

For example, in the case where a liquid crystal panel or an organic EL panel is used as the display portion 6, the actual display is performed only with respect to the opened display portion 6, and the display is configured to be off with respect to the closed display portion 6. For example, only the allocation of the content page and the supplying of the display data are performed, and only the display (emission) is configured to be off. In the case of the liquid crystal panel, the back light is turned off. In the organic EL panel, only the self-emission operations are set to be stopped.

By doing so, it is possible to reduce the power consumption of the electronic book 1.

However, in the case of using an electronic paper, which consumes power only during the display updating period, as the display portion 6, since there is almost no power consumption caused by the display, there is no problem caused by the ordinary display.

With respect to the selection of the updating mode, although the first to fourth modes are selected as the example of the process of FIGS. 15 to 17, the other various examples of the selecting processes may be considered.

In addition, a switch may be prepared on the front cover portion 3 or the like, so that the user may designate the updating mode by the switch.

In the embodiment, although the display portions 6 are disposed on the facing left and right page, in some aspects the display portion 6 may be disposed on the one side page.

In addition, in some aspects, several sheets 2 are rotated without limit by using the book spine 5 as the central axis, so that the pages may be forwarded.

The page calculation as the first to fourth modes is described in the case where the two facing left and right pages exist with respect to the display pages and the content pages. However, the calculation may be performed by treating this as one facing page.

In addition, the display portions 6 are provided to the front cover portion 3 and the back cover portion 4, and the display portions 6 may be treated as the first page and the last page.

### 7. Program

The program according to the embodiment is a program which allows the controller 21 (CPU) to execute the aforementioned processes.

For example, if the electronic book 1 is powered on, the controller 21 starts to read the program according to the embodiment stored in the non-volatile memory 23 and writes the program in the high speed memory 22. If the transmission of the program to the high speed memory 22 is completed, the controller 21 sequentially reads the program displayed on the high speed memory 22 to perform each of the processes.

The program allows the controller 21 which is a calculation process apparatus to execute a step of determining the content page which is to be displayed on the display portion 6 which is next in the opened state through calculation using the number of target display portions which is the number of display portions 6 which is changed from the current state to the next opened state in one of page forward direction and the page backward direction, the number of target content pages which are changed from the current state to the next viewed state in one of the page forward direction and the page backward direction, and the page difference value with respect to the display portion page which is next in the opened state (the process of Step F307 of FIG. 12).

In addition, the program allows the controller 21 which is a calculation process apparatus to execute a step of performing control of displaying the determined content page on the display portion 6 which is next in the opened state (the process of Step F309 of FIG. 12).

More specifically, the program allows the controller 21 to perform the processes of FIG. 9 (or FIG. 19), FIG. 10, FIG. 12, FIG. 13, FIG. 14, and FIG. 15 (or FIG. 16 and FIG. 17). In addition, in some cases, the processes of FIG. 20 and FIG. 21 may be allowed to be performed.

By the program according to the embodiment, the display apparatus (electronic book 1) may be implemented.

This program may be recorded in an HDD as a recording medium built in an apparatus such as a personal computer, a ROM in a microcomputer having a CPU, a flash memory, or the like in advance.

Alternatively, the program may temporarily or permanently stored (recorded) in a removable recording medium such as a flexible disk, a CD-ROM (Compact Disc Read Only Memory), am MO (Magneto-Optical) disk, a DVD, a Blu-ray disc, a magnetic disk, a semiconductor memory, or a memory card. This removable recording medium may be provided by so-called package software.

Some embodiments may comprise a computer-readable storage medium (or multiple computer-readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage media) encoded with one or more programs (e.g., a plurality of instructions) that, when executed on one or more computers or other processors, perform methods that implement the various embodiments discussed above. As is apparent from the foregoing examples, a computer-readable storage medium may retain information for a sufficient time to provide computer-executable instructions in a non-transitory form.

In addition, besides the configuration where the program may be installed from the removable recording medium to the personal computer, the program may be downloaded from a download site via a network such as a LAN (Local Area Network) or the Internet.
Use of ordinal terms such as “first,” “second,” “third,” etc., in the claims to modify a claim element does not by itself connote any priority, precedence, or order of one claim element over another or the temporal order in which acts of a method are performed. Such ordinal terms are used merely as labels to distinguish one claim element having a certain name from another element having a same name (but for use of the ordinal term) to distinguish the claim elements.
Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

### REFERENCE SIGNS LIST

1: electronic book
2: sheet
3: front cover portion
4: back cover portion
5: book spine
6: display portion
7: page updating button
21: controller
22: high speed memory
23: non-volatile memory
24: content data input unit
25: input unit
26: display data generation unit
27: manipulator
28: sensor unit
31: content input/storage controller
32: display calculation unit
33: input sensing unit
34: display state management unit
35: display information management unit
36: timer unit

1. Apparatus for displaying content on an electronic book having a plurality of physically distinct displays configured to be turned by a user, the plurality of displays forming a number Da of available display pages, the electronic book being configured to allow the user to view at least a portion of a content unit divisible into a number Ca of available content pages, the apparatus comprising:
at least one processor; and
at least one memory storing processor-executable instructions that, when executed by the at least one processor, perform a method comprising:
determining a number Dn of a currently opened display page from among the available display pages;
determining a number Dm of a first display page different from the currently opened display page from among the available display pages, and a difference Dd between Dm and Dn;
determining a number Dr of display pages between the currently opened display page and a beginning or end of the available display pages;
calculating a first content page from among the available content pages to display on the first display page, based at least in part on a ratio between Dd and Dr; and
causing the first content page to be displayed on the first display page.

2. The apparatus of claim 1, further comprising:
a sensor unit configured to detect the currently opened display page from among the available display pages; and
a display data generation unit configured to display the first content page on the first display page.

3. The apparatus of claim 1, wherein the method further comprises:
determining a number Cn of a current content page displayed on the currently opened display page;
determining a number Dm1 of a second display page different from the currently opened display page from among the available display pages, wherein a difference Dd1 between Dm1 and Dn is less than a predetermined threshold; and
calculating a number Cm1 of a second content page different from the current content page from among the available content pages to display on the second display page, such that a difference Cd1 between Cm1 and Cn is equal to Dd1.

4. The apparatus of claim 1, wherein calculating the first content page comprises:
determining a number Cn of a current content page displayed on the currently opened display page;
determining a number Cr of content pages between the current content page and a beginning or end of the available content pages; and
calculating a number Cm of the first content page, and a difference Cd between Cm and Cn, such that a ratio between Cd and Cr has a predetermined relationship with the ratio between Dd and Dr.

5. The apparatus of claim 4, wherein the number Cm is calculated as
Dm−Ca/Da.

6. The apparatus of claim 4, wherein the number Cm is calculated as
((Dm−Dn)−(Ca−Cn)/(Da−Dn))+Cn.

7. The apparatus of claim 4, wherein the number Cm is calculated as
Cn−Dm/Dn.

8. The apparatus of claim 1, wherein the processor-executable instructions, when executed, cause the processor to perform the calculating periodically in response to a value of a timer unit.

9. The apparatus of claim 1, wherein the processor-executable instructions, when executed, cause the processor to perform the calculating in response to the user opening the first display page.

10. The apparatus of claim 1, wherein the processor-executable instructions, when executed, cause the processor to cause the first content page to be displayed only when the first display page is open, and not when the first display page is closed.

11. The apparatus of claim 1, wherein a subset of the available content pages are designated as index pages, and wherein calculating the first content page comprises:
determining a calculation result based at least in part on the ratio between Dd and Dr; and
adjusting the calculation result such that the calculated first content page is an index page.

12. A method for displaying content on an electronic book having a plurality of physically distinct displays configured to be turned by a user, the plurality of displays forming a number Da of available display pages, the electronic book being configured to allow the user to view at least a portion of a content unit divisible into a number Ca of available content pages, the method comprising:
determining a number Dn of a currently opened display page from among the available display pages;
determining a number Dm of a first display page different from the currently opened display page from among the available display pages, and a difference Dd between Dm and Dn;
determining a number Dr of display pages between the currently opened display page and a beginning or end of the available display pages;
calculating, using at least one processor, a first content page from among the available content pages to display on the first display page, based at least in part on a ratio between Dd and Dr; and
causing the first content page to be displayed on the first display page.

13. The method of claim 1, further comprising:
detecting, via a sensor unit, the currently opened display page from among the available display pages; and
displaying, via a display data generation unit, the first content page on the first display page.

14. The method of claim 12, further comprising:
determining a number Cn of a current content page displayed on the currently opened display page;
determining a number Dm1 of a second display page different from the currently opened display page from among the available display pages, wherein a difference Dd1 between Dm1 and Dn is less than a predetermined threshold; and
calculating a number Cm1 of a second content page different from the current content page from among the available content pages to display on the second display page, such that a difference Cd1 between Cm1 and Cn is equal to Dd1.

15. The method of claim 12, wherein calculating the first content page comprises:
determining a number Cn of a current content page displayed on the currently opened display page;
determining a number Cr of content pages between the current content page and a beginning or end of the available content pages; and
calculating a number Cm of the first content page, and a difference Cd between Cm and Cn, such that a ratio between Cd and Cr has a predetermined relationship with the ratio between Dd and Dr.

16. The method of claim 12, wherein the calculating is performed periodically in response to a value of a timer unit.

17. The method of claim 12, wherein the first content page is displayed only when the first display page is open, and not when the first display page is closed.

18. The method of claim 12, wherein a subset of the available content pages are designated as index pages, and wherein calculating the first content page comprises:
determining a calculation result based at least in part on the ratio between Dd and Dr; and
adjusting the calculation result such that the calculated first content page is an index page.

19. At least one computer-readable storage medium encoded with a plurality of computer-executable instructions that, when executed, perform a method for displaying content on an electronic book having a plurality of physically distinct displays configured to be turned by a user, the plurality of displays forming a number Da of available display pages, the electronic book being configured to allow the user to view at least a portion of a content unit divisible into a number Ca of available content pages, the method comprising:
determining a number Dn of a currently opened display page from among the available display pages;
determining a number Dm of a first display page different from the currently opened display page from among the available display pages, and a difference Dd between Dm and Dn;
determining a number Dr of display pages between the currently opened display page and a beginning or end of the available display pages;
calculating a first content page from among the available content pages to display on the first display page, based at least in part on a ratio between Dd and Dr; and
causing the first content page to be displayed on the first display page.

20. The at least one computer-readable storage medium of claim 19, wherein the method further comprises:
detecting, via a sensor unit, the currently opened display page from among the available display pages; and
displaying, via a display data generation unit, the first content page on the first display page. cm 3000. TAGMATION.
